(19) United States
(12) Patent Application Publication
(10) Pub. No.: US 2026/0174094 A1
(43) Pub. Date: Jun. 25, 2026

(54) COCOA-FREE CHOCOLATE

(71) Applicant: NUKOKO LIMITED, London (GB)

(72) Inventors: Ross NEWTON, Guildford (GB); Kit TOMLINSON, Guildford (GB); David SALT, Guildford (GB); David GOPAULCHAN, Nottingham (GB); Tristan DEW, Nottingham (GB)

(21) Appl. No.: 19/124,897

(22) PCT Filed: Nov. 3, 2023
(86) PCT No.: PCT/GB2023/052879

§ 371 Date: Apr. 28, 2025

(30) Foreign Application Priority Data
Nov. 3, 2022 (GB) 2216336.4

(51) Int. Cl. A23G 1/56; A23G 1/32; A23G 1/48

(52) U.S. Cl. CPC A23G 1/56; A23G 1/32; A23G 1/48

(57) ABSTRACT

The invention relates to non-cocoa or cocoa-free chocolate analogues and methods for making such analogues. The invention also extends to fermentation methods for producing cacao/cocoa-free chocolate analogues and to foodstuffs and cosmetics comprising such analogues.

The present invention relates to non-cocoa or cocoa-free chocolate analogues and methods for making such analogues. The invention also extends to fermentation methods for producing cacao/cocoa-free chocolate analogues and to ingredients, foodstuffs and cosmetics comprising such analogues.

Cacao is the seed from the tropical tree Theobroma cacao, from which cocoa and chocolate are made, which are in high demand, and relatively expensive ingredients used in a wide variety of food products. There are many well-documented health benefits associated with cacao and products made from cacao seeds, such as chocolate and cocoa. For example, studies suggest that dark chocolate can reduce the risk of cardiovascular disease. Furthermore, unsweetened cocoa is relatively low in calories, and contains essential minerals that support heart, bone, and immune system health.

The taste of cocoa is also cherished worldwide and is the basis for drinks and confectionary products of variety of taste profiles. There are a wide variety of cocoa flavours, depending on, for example, the type of cacao beans and the region they are grown, the amount of sugar present, the amount of free amino acids present, and the cocoa colour pigments.

However, several side effects associated with the use of cocoa have been reported. These include triggering migraines in sensitive people, increasing the risk of bleeding and bruising in people with bleeding disorders, worsening irregular heartbeat, interfering with blood sugar control during and after surgical procedures or worsening the symptoms of Gastroesophageal Reflux Disease (GERD) or Irritable bowel syndrome (IBS). The theobromine content of cocoa has also been associated with severe toxicity in dogs, which is why chocolate should not be given to pet dogs.

Chocolate is the 5th highest carbon emitting food product globally. Government, industry legislations and customers all demand lower carbon emitting food products in the market. Furthermore, the future of cocoa and chocolate industry is at stake due to increasing concerns around climate change, with some models showing that from as early as 2030, 28% of all cocoa imports will be affected, which in turn will result in a huge drop in the cocoa supply to the global market. In addition, given that cacoa beans are shipped on average about 3000 miles before the resulting chocolate arrives at a local supermarket's shelves, prices are increasing drastically for consumers. Moreover, there are circa 1.56 million children, some as young as 5 years old working on cacao farms around the world, a situation compounded by the chocolate companies' reluctance to increase the price paid to cocoa farmers for their cacao beans. Coupled with increasing consumer market demands, this means that an alternative option to cacao-based chocolate is required.

To overcome these challenges, synthetic chocolate and cocoa flavours made from various alternative synthetic compounds have been developed. However, these chocolate analogues fall short of mimicking the exact taste of cocoa and chocolate, exhibiting strong off-tastes and aromas, and some are also associated with a poor safety profile.

There is, therefore, a need to provide an alternative to chocolate and cocoa that can be created from locally sourced natural products, and which closely mimic the original chocolate that is made of cacao beans (in terms of flavour, aroma and texture), but without exhibiting the various related drawbacks discussed above.

The inventors have set out to develop a novel cacao-bean free chocolate/cocoa analogue. After conducting a thorough analysis of various locally sourced produces (i.e. legumes), the inventors have identified a number of candidate legumes that can be used to successfully substitute cocoa in chocolate formulations, and have developed and optimised a new method of making an alternative chocolate/cocoa analogue.

In one embodiment, the process involves microbial fermentation treatment of the legume, using yeast and/or bacteria to result in a cacao bean-free chocolate analogue, with a similar taste and aroma to normal (cacao bean) chocolate. In another embodiment, the process involves two separate treatments of the legume. In one treatment, the legume is exposed to microbial fermentation, and in the other treatment, the legume is treated in the absence of any exogenously added micro-organisms. A proportion of the microbially fermented legume is then blended with a proportion of the non-microbially treated legume to result in cacao bean-free chocolate analogue, again with a similar taste and aroma to normal (cacao bean) chocolate.

Thus, in a first aspect of the invention, there is provided a cacao bean-free chocolate analogue comprising a microbially and/or non-microbially fermented legume.

In a second aspect of the invention, there is provided a cacao bean-free chocolate analogue comprising a microbially fermented legume.

In a third aspect, there is provided a method of producing a cacao bean-free chocolate analogue, the method comprising contacting a legume with at least one micro-organism under conditions suitable for the at least one micro-organism to ferment the legume to thereby form a cacao bean-free chocolate analogue comprising a microbially fermented legume.

In a fourth aspect, there is provided a cacao bean-free chocolate analogue obtained, or obtainable, by the method of the third aspect.

It will be appreciated that the cacao bean-free chocolate analogue as described herein may also be referred to as a non-cocoa chocolate analogue.

Although substitutes for cacao beans, such as cupuaçu (Theobroma grandiflorum) and carob (Ceratonia siliqua), are already known for their cocoa-like qualities, these are comparatively underdeveloped crops with similar burdens of seasonal variability and global transportation cost. Advantageously, however, the inventors of the cacao bean-free chocolate analogue of the first, second or fourth aspect have identified several legume candidates that are low cost, agriculturally well-established and grown comparatively close to production facilities in Europe. Moreover, the chocolate analogue of the invention closely resembles or mimics traditional chocolate that is made of cacao beans, in terms of flavour and aroma (i.e. notes and tones) and texture.

It will be appreciated that a legume is a plant of family Fabaceae or Leguminosae, or the fruit or seed of such a plant. When used a dry grain, the seed can also be called a pulse. The legume may be selected from a bean, soybean, pea, chickpea, peanut, lentil, lupin, mesquite, carbo, tamarind, alfalfa and clover.

Preferably, the fermented legume comprises vicilin. Vicilin is a legumin-associated globulin storage protein. The globulin fraction, identified as vicilin class globulins (VCG; also known as a 7S storage protein) contains a 66 kDa common precursor, which following proteolysis is comprised of 3 polypeptide subunits (47, 31, and 14.5 kD; Biehl et al., 1982, Spencer and Hodge, 1992; Voight, Biehl and Wazir, 1993). More recently, the 14.5-15 kD band commonly observed via SDS PAGE of cacao proteins, has been shown to be a composite of 3 lower polypeptides of 14.5, 15 and 15.5 kDa in size (Kratzer et al., 2009). As is common for vicilins, the precursor can form trimers. Warwicker and O'Connor (1995) constructed a homology model of cacao vicilins of 138 kDa in size, which is close to previously observed cacao trimer sizes of 144 and 150 kDa (Macdonald et al., 1991; Voight, Biehl and Wazir., 1993, respectively). No 11S legumin has been identified in Cacao (Voight, Biehl, & Wazir 1993).

During microbial or non-microbial fermentation, VCG is degraded by two key enzymes. Firstly, aspartic endoprotease causes the release of hydrophobic oligopeptides, i.e. oligopeptides ending in a hydrophobic residue. Secondly, an endopeptidase (carboxypeptidase) further degrades these products to form hydrophilic peptides and hydrophobic free amino acids (Voight and Biehl, 1995). The activities of these enzymes change during bean fermentation; aspartic endopeptidase peaking midway, and carboxypeptidase peaking at the end of a 144-hr fermentation (Amin, Jinap and Jamilah, 1997). As a result, the profile of cacao VCG also changes during fermentation. For example, Kumari et al. (2016) observed major protein bands following SDS-PAGE of unfermented cacao protein, namely vicilin subunits (15, 31, and 47 kDa), albumin (21 kDa), and also a presumed kinase superfamily protein at 43 kDa. During the first 72 hours of fermentation the kDa subunit was the major target for vicilin proteolysis, whilst 31 and 47 kDa only started to breakdown after 96 hrs. This hydrolysis was rapid and complete however, and by 120 hrs both the 31 and 47 kDa bands were completely degraded, whilst some 15 kDa band persisted. In addition, aspartic endoprotease and carboxypeptidase have quite different pH optima (pH 3.5 vs. 5.5-6, respectively) and during in vitro proteolysis of VCG isolates, “nutty” aroma precursors were more prevalent across pH values 4.8-5.6, whilst lower pH values (4.4-5.2) were associated with “cocoa” aroma precursors and a more complete protein hydrolysis, with a greater release of free amino acids (Voigt et al., 2018). However, as Biehl et al. (1985) note, low pH during bean fermentation (<pH 5) can be associated with a loss in flavour and aroma, hence ‘complete proteolysis’ is not desirable.

Preferably, the fermented legume comprises convicilin. Convicilin is a legumin-associated globulin storage protein.

Preferably, the fermented legume (which may be microbially and/or non-microbially fermented) is selected from a group of legumes consisting of: adzuki bean (Phaseolus angularis); alfalfa (Medicago sativa); bambara (vigna subterranean); black gram (vigna mungo); chickpea (Cicer arietinum); cowpea (vigna unguiculata); faba bean (Vicia faba); common bean (Phaseolus vulgaris); lima bean (phaseolus lunatus); lentils (lens culinaris or Lens esculenta); lupins (lupinus albus, lupinus angustifolius, or lupinus luteus); moth bean (vigna aconitifolia); mung bean (vigna radiate); pea (Pisum sativum); pigeon pea (cajanus cajan); sesame (Sesamum indicum); scarlett runner bean (Phaseolus coccineus); soy (glycine max); and vetch (Vicia sativa).

The inventors identified the physico-chemical compositions of the above listed legumes based on the data provided by the United States Department of Agriculture (USDA). The data for each of the legumes are summarised in Table 2 in the examples. However, an overview of the protein profile and phenolic content of the selected legume candidates is provided below.

Adzuki bean: Phaseolus angularis

Almost half of adzuki (or red bean) proteins are globulin, and the majority (approximately 80%) of these are 7s vicilin. It is understood that catechin, quercetin glycosides, procyanidin and protocatechuic acid are the main polyphenols found in adzuki beans.

Alfalfa: Medicago sativa

Alfalfa contains three major storage proteins consisting primarily of approximately 10% of 7s-alfin, 30% of 11s-medicagin, and 20% 2S-albumin of the total protein content. Regarding the phenolic profile of alfalfa seeds, the major flavonoids found in the aerial parts of this plant are glycosides of the flavones tricin and apigenin.

Bambara: Vigna subterranea

Bambara groundnut has a total protein content ranging 18-27%, with the vicilins protein accounting for 46% of the total and legumins and albumins accounting for 29 and 20.5%, respectively. As for the phenolic content of bambara, flavonols (in particular rutin) and phenolic acids, such as chlorogenic and ellagic acids, have been found in bambara species, with levels generally higher in red and brown beans compared to those in brown eye and black eye types. The phenols were concentrated in the hull.

Black gram: Vigna mungo

Vicllins constitute around 50% of total soluble protein content in black gram (or mungo_beans. It was shown that the distribution of phenolic acids in black gram consisting mainly of ferulic acid is concentrated in plumule and seed coat. The total polyphenols and total anthocyanins distribution ranged 0.9-134.7 and 5.9-86.8 mg/100 g, respectively, with the highest concentrations found in the seedcoat.

Chickpea: Cicer arietinum

Chickpea's protein profile comprises 56% globulin, 18% glutelin, 12% albumin and 2.8% prolamin. The intact 11s and 7s globulins have been identified and the vicilin subunits were considered as analogous to 7S subunits observed in pea and soybean extracts. Over 96 polyphenols have been identified in chickpea with catechin (and a related pentoside), sinapic acid hexoside, gallic acid and glycosides of kampferol being major contributors.

Cowpea: Vigna unguiculata

Globulins represent 51-72% of total cowpea protein, of which the principal component is the 7s vicilin-like β-vignin. This shares approximately 62% of its amino acid sequence with the a subunit of B conglycinin (from Soy). Analysis of four cowpea varieties showed total polyphenol (mainly flavonoids and phenolic acids) contents ranged 642-2376 ug/g with Agrinawa showing the highest content. Another important phenolic compound found in cowpeas is catchein-3-O-glucoside. Interestingly, black eye peas have also been shown to contain procyanidins.

Faba bean: Vicia faba

Also known as the broad bean, approximately 80% of Faba proteins are globulins consisting of both 11s to 7s. The protein profile of Faba beans is complex, and contains both vicilin and convicilin. Faba beans are reported as a good source of catechin, epicatechin and procyanidins.

Common bean: Phaseolus vulgaris

P. vulgaris is a highly diverse species, encompassing several well-known bean varieties, such as French bean, Kidney bean, Black turtle, Pinto and Navy beans.

They are typically rich in globular proteins. The 7S protein in common bean is referred to as “Phaseolin” and represents 50% of total protein in French bean. Whilst most P. vulgaris varieties contain similar phenolic acids, there is diversity between their monomeric flavonoid profiles linked in part to their colour. For example, black beans are a good source of anthocyanidins, pinto beans are rich in kaempferol glycosides, red kidney beans are dominated by both quercetin and kaempferol glycosides whilst navy beans appear to have little to no detectable flavonoid content. Several cultivated varieties of P. vulgaris bean have considerably higher proanthocyanidin contents than other Phaseolus species, including P. lunatus, P. polyanthus, P. coccineus and P. zebra.

Lima bean: Phaseolus lunatus

Lima beans contain vicilins (phaseolins). Lima flour contains similar levels of p-coumaric and ferulic acids. Other phenolic acids and flavonoids have been found in lima seed oil and include b-coumaric acid and its downstream metabolite rosmarinic acid.

Lentils: Lens culinaris/Lens esculenta

Globulins and albumins represent 42 and 11% of total lentil's protein content, respectively. However, the main native globulin in lentil representing 34% of total protein was found to be a legumin-type globulin. Lentils also contain a wide range of flavan-3-ols, procyanidins, and flavonol glycosides, in particular, catechin glucoside, quercetin-diglucioside and procyanidin dimers.

Lupins: Lupinus albus/Lupinus angustifolius/Lupinus luteus

Lupins are a high protein seed that also contain around 10% lipid. The blue (L. angustifolius or narrowleaf) and yellow (L. luteus) lupins are typically grown as animal feed, and white lupin (L. albus) is predominately used for human consumption. The ratio of globulins to albumins in lupin species is approximately 9:1, and are split into α-conglutin (11s, legumin-like) β-conglutin (7s, vicilin like) and two minor proteins referred to as γ- and Δ-conglutin. Regarding the phenolic profile of Lupinus seeds, total polyphenol content was made of gallic acid equivalents/100 g, and several phenylpropanoids (such as ferulic acid, catechol) benzoic acids (such as vanillin, vanillic acid) and flavones (such as agpigenin-7-glucoside, appin) in blue, yellow and white lupin. In addition, both lupin leaves and seeds are good source of isoflavones, predominantly aglycone genistein and several related glycosides and 2′hydroxy forms.

Moth bean: Vigna aconitifolia

Globulins account for 63.9% of total soluble moth bean protein, with glutelin, albumin and prolamin accounting for 27.8, 5.1 and 3.2%, respectively. The total polyphenols in 22 moth bean species ranged from 57 #23 to 1034 #12 mg GAE/100 g, with catechin, tannic acid, and gallic acid as the major contributors.

Mung bean: Vigna radiata

Mung bean (or green gram) contains both 7S and 11S globulins (3 and 8%, respectively), although its major storage protein is an 8S vicilin. Mung beans also contain a diverse profile of flavonoids and phenolic acids with glycosylated forms of the flavone apigenin being the dominant forms.

Pea: Pisum sativum

The protein profile of different pea species show that their globulin content accounts for 49.2-81.8% of total proteins with vicilin being the most abundant at 26.3-52.0% of total globulin content. Legumin content ranges from 5.9-24.5%, and convicilin accounts for only 3.9-8.3% total globulins. Although hydroxybenzoic acids dominate the phenolic profile of pea cotyledon, polyphenols in the seed coat are predominantly flavone (such as luteolin, apigenin) and flavonol (such as quercetin) glycosides along with lower levels of flavanol-3ol monomers and procyanidins. A wide variety of quercetin glycosides are found in Pisum sativum leaves.

Pigeon pea: Cajanus cajan

Intact Pigeon pea contains vicilin. The phenolic profile of Cajanus cajan is formed of glycosylated flavones orientin and vitexin, together with canjanol and cajanin.

Sesame: Sesamum indicum

Whilst approximately 67% of sesame proteins are globulins, 7s globulins represent only 5% of total protein content. The major polyphenosl in sesame are lignans, in particular, sesamin, sesamolin, sesamol and sesaminol. Flavonoids and phenolic acids, such as catechin and 1,2 dihydoxybenzoic acid, have also been reported in sesame seed.

Scarlett runner bean: Phaseolus coccineus

The major storage protein in Phaseolus coccineus are intact vicilins. On the other hand, caffeic and chlorogenic acids are the major phenolic compounds found in

Scarlett runner bean seed oil, whilst the seed coat is an excellent source of high molecular weight procyanidins.

### Soy: Glycine max

The vicilin storage protein of soybean is known as b-conglycinin, which exists as a trimer of three glycosylated peptides. More than 70% of the protein content of soy is comprised of 7S and 11s (glycinin) globulins, which are valued in the food industry for their nutritional value and gelling properties. Soy is also a rich source of the isoflavones genistein, daidzein and glycitein, which occur predominantly as malonic acid conjugates of the 7-O-glucosides genistin, daidzin and glycetin.

Vetch: Vicia sativa

Vetch's proteins consist of approximately 50.8% globulin AND 43.6% albumin. The globulin faction is dominated by a legumin-like 10 and 6S storage proteins referred to as a vicinins. Phenolic compounds, such as kaempferol glycosides, myricetin and naringenin, have been reported in the roots and leaves of V. sativa. Furthermore, the total polyphenol content of vetch seeds is more than three times greater than that of soy.

Table 2 summarises the physico-chemical characteristics of the legume candidates based on the data provided by the United States Department of Agriculture (USDA).

Advantageously, the inventors have assessed the protein, polyphenol and lipids profiles of the nineteen legume candidates and assigned a similarity to cocoa score to each legume based on an aggregate scoring system. Where the relative abundance and protein profile of 7S VCG have been characterised, the legumes were scored in terms of their relative similarity to cocoa. Additional factors, such as a polyphenolic profile rich in flavan-3-ols and procyanidins, or a high fat content were also taken into consideration. Table 3 summarises the profile and score achieved by each of the legume candidates.

Using significant inventor endeavour, and based on the inventors' analysis, six of the above listed legumes are believed to display characteristics that are substantially similar to cacoa/cocoa beans (i.e. legumes with a total score ≥4 in Table 3), and these include faba, white lupin, pea, moth beans, Scarlett runner and sesame.

Accordingly, in a preferred embodiment, the legume which may be fermented is selected from the group consisting of: faba bean (Vicia faba); white lupin (lupinus albus); pea (Pisum sativum); moth bean (vigna aconitifolia); Scarlett runner bean (Phaseolus coccineus); and sesame (Sesamum indicum). Most preferably, the fermented legume is faba bean.

However, Example 7 explains how various beans (e.g. Lupin, green pea, moth, aduki and hemp seeds) other than the fava bean may also be used to develop cocoa-like analogue, and so are also preferred.

In one embodiment, the at least one micro-organism used for the microbial fermentation may be selected from a yeast and/or a bacterium. In one embodiment, the microbial fermentation comprises substantially or only yeast. Preferably, at least 70%, 80% or 90% of the micro-organisms in the fermentation comprise yeast cells. More preferably at least 95%, 96%, 97%, 98%, 99% or 100% of the micro-organisms in the fermentation comprise yeast cells.

In another embodiment, the microbial fermentation comprises substantially or only bacteria. Preferably, at least 70%, 80% or 90% of the micro-organisms in the fermentation comprise bacterial cells. More preferably at least 95%, 96%, 97%, 98%, 99% or 100% of the micro-organisms in the fermentation comprise bacterial cells.

In yet another embodiment, the microbial fermentation comprises yeast and bacteria. Preferably, the ratio of yeast to bacterial cells is about 50:50. However, other ratios are envisaged, and include 10:90, 20:80, 30:70, 40:60 yeast cells to bacterial cells, or, alternatively, 10:90, 20:80, 30:70, 40:60 bacterial cells to yeast cells.

In some embodiments, when yeast cells are used in the microbial fermentation, only one species of yeast is used. Similarly, when bacterial cells are used in the microbial fermentation, in some embodiments, only one species of bacteria is used. However, in other embodiments, the microbial fermentation may comprise using one or more yeast species and/or one or more bacterial species. For example, two, three or four or more different spaces of yeast or bacteria may be used.

The bacterium may be Gram-positive or Gram-negative. Preferably, the Family of bacterium may be selected from a group of bacteria Families consisting of: Lactobacillies; and Acetobacter. Preferably, the species of bacterium may be selected from a group of bacterial species consisting of: Lactobacillus fermentum; Lactobacillus plantarum; and Acetobacter pasterianus. Example 6 describes the effects of these different micro-organisms on the resultant chocolate analogue.

Preferably, the genus of yeast may be selected from a group of yeast genuses consisting of: Pichia; Hanseniaspora; and Saccharomyces. Preferably, the species of yeast may be selected from a group of yeast species consisting of: Pichia kudriavzevii; Hanseniaspora opuntiae; and Saccharomyces cerevisiae.

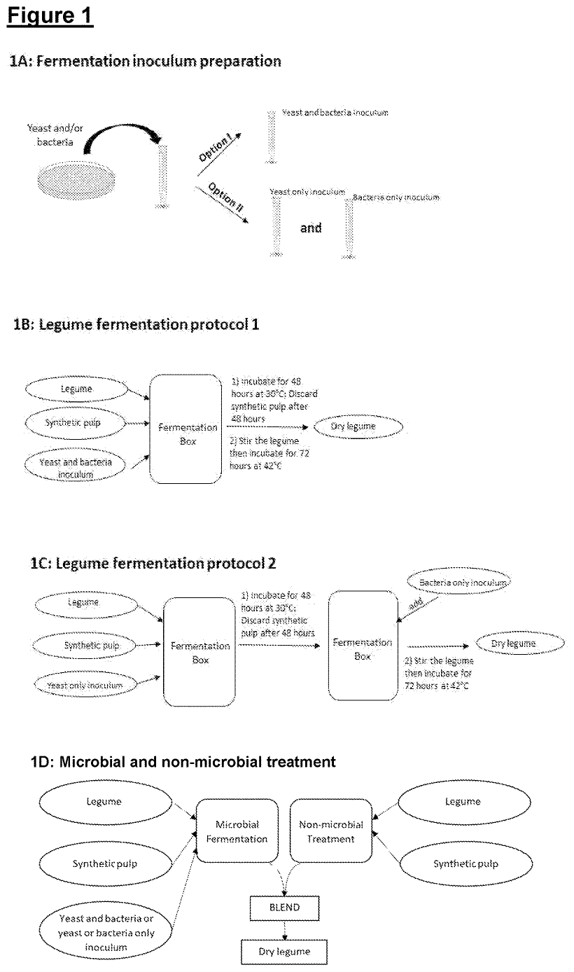

Preferably, the microbial fermentation method comprises growing at least one micro-organism and the legume in growth media (referred to in the examples and FIG. 1 as a “synthetic pulp”). The growth media is a solution of chemicals and nutrients used to ferment the legume. It will be appreciated that the legume, the growth media and the at least one micro-organism collectively form a microbial fermentation mixture.

Accordingly, it will be appreciated that, in one embodiment, as shown in FIGS. 1B and 1C, the method comprises microbial fermentation treatment of the legume, preferably Fava bean, in growth media. Two types of fermentation inoculums may be prepared, one which comprises both yeast and bacteria (option 1), and the second which comprises either yeast only or bacteria only (option 2). FIG. 1B shows an exemplary legume fermentation process in which the fermentation inoculum according to option 1 is used to result in the cacao bean-free chocolate analogue, and FIG. 1C shows an exemplary legume fermentation process in which the fermentation inoculum according to option 2 is used to result in the cacao bean-free chocolate analogue.

In another embodiment, however, as shown in FIG. 1D, the method preferably comprises two separate treatments of the legume (preferably, Fava bean). The method preferably comprises a first treatment in which the legume is microbially fermented (either option 1 or option 2), preferably in growth media, to produce a microbially fermented legume, and a second treatment in which, separately, the legume is non-microbially fermented, preferably in an incubation solution, in the absence of any exogenously added micro-organisms to produce non-microbially treated legume. The method then preferably comprises combining a proportion of the microbially fermented legume with a proportion of the non-microbially fermented legume to result in the cacao bean-free chocolate analogue.

The ratio of microbially fermented legume to non-microbially fermented legume is preferably between about 10%: 90% and 90%: 10%, or about 50%: 50%.

In one embodiment, the growth media or incubation solution may comprise one or more saccharide. Preferably, the one or more saccharide may be selected from a group consisting of: sucrose; glucose; fructose; carboxymethyl cellulose high V; carboxymethyl cellulose low V; and/or pectin.

A suitable concentration of sucrose may be between about 0.1% (w/v) and 10% (w/v), preferably between about 0.5% (w/v) and 7% (w/v), more preferably between about 1% (w/v) and 5% (w/v), and most preferably between about 2% (w/v) and 3% (w/v). About 2.5% (w/v) of glucose is most preferred. A suitable concentration of glucose may be between about 0.1% (w/v) and 10% (w/v), preferably between about 1% (w/v) and 8% (w/v), more preferably between about 2% (w/v) and 6% (w/v), and most preferably between about 3% (w/v) and 5% (w/v). About 4% (w/v) of glucose is most preferred. A suitable concentration of fructose may be between about 0.1% (w/v) and 10% (w/v), preferably between about 1% (w/v) and 8% (w/v), more preferably between about 3% (w/v) and 7% (w/v), and most preferably between about 4% (w/v) and 6% (w/v). About 5% (w/v) of fructose is most preferred. A suitable concentration of carboxymethyl cellulose high V may be between about 0.005% (w/v) and 5% (w/v), preferably between about 0.005% (w/v) and 2% (w/v), more preferably between about 0.005% (w/v) and 1% (w/v), and most preferably between about 0.05% (w/v) and 0.5% (w/v). About 0.1% (w/v) of carboxymethyl cellulose high V is most preferred. A suitable concentration of carboxymethyl cellulose low V may be between about 0.005% (w/v) and 5% (w/v), preferably between about 0.005% (w/v) and 2% (w/v), more preferably between about 0.005% (w/v) and 1% (w/v), and most preferably between about 0.05% (w/v) and 1% (w/v). About 0.8% (w/v) of carboxymethyl cellulose low V is most preferred.

A suitable concentration of pectin may be between about 0.01% (w/v) and 10% (w/v), preferably between about 0.01% (w/v) and 5% (w/v), more preferably between about 0.1% (w/v) and 3% (w/v), and most preferably between about 0.5% (w/v) and 2% (w/v). About 1% (w/v) of pectin is most preferred.

The growth media or incubation solution may comprise one or more salt. Preferably, the one or more salt may be selected from a group consisting of: calcium lactate pentahydrate; magnesium sulfate heptahydrate; and manganese sulfate monohydrate. A suitable concentration of calcium lactate pentahydrate may be between about 0.001% (w/v) and 2% (w/v), preferably between about 0.001% (w/v) and 1% (w/v), more preferably between about 0.01% (w/v) and 0.75% (w/v), and most preferably between about 0.05% (w/v) and 0.5% (w/v). About 0.1% (w/v) of calcium lactate pentahydrate is most preferred. A suitable concentration of magnesium sulfate heptahydrate may be between about 0.001% (w/v) and 1% (w/v), more preferably between about 0.001% (w/v) and 0.5% (w/v), and most preferably between about 0.01% (w/v) and 0.1% (w/v). About 0.05% (w/v) of magnesium sulfate heptahydrate is most preferred. A suitable concentration of manganese sulfate monohydrate may be between about 0.001% (w/v) and 1% (w/v), more preferably between about 0.001% (w/v) and 0.5% (w/v), and most preferably between about 0.01% (w/v) and 0.1% (w/v). About 0.02% (w/v) of manganese sulfate monohydrate is most preferred.

The growth media or incubation solution may comprise one of one or more protein hydrolysate. Preferably, the one or more protein hydrolysate is peptone. A suitable concentration of peptone may be between about 0.001% (w/v) and 7% (w/v), preferably between about 0.001% (w/v) and 5% (w/v), more preferably between about 0.01% (w/v) and 2% (w/v), and most preferably between about 0.05% (w/v) and 1% (w/v). About 0.5% (w/v) of peptone is most preferred.

The growth media or incubation solution may comprise a yeast extract. A suitable concentration of yeast extract may be between about 0.001% (w/v) and 7% (w/v), preferably between about 0.001% (w/v) and 5% (w/v), more preferably between about 0.01% (w/v) and 2% (w/v), and most preferably between about 0.05% (w/v) and 1% (w/v). About 0.5% (w/v) of yeast extract is most preferred.

The growth media or incubation solution may comprise a surfactant. Preferably, the surfactant is Tween 80. A suitable concentration of Tween 80 may be between about 0.001% (w/v) and 2% (w/v), preferably between about 0.001% (w/v) and 1% (w/v), more preferably between about 0.01% (w/v) and 0.75% (w/v), and most preferably between about 0.05% (w/v) and 0.5% (w/v). About 0.1% (w/v) of Tween 80 is most preferred.

The growth media or incubation solution may comprise citric acid. A suitable concentration of citric acid may be between about 0.0001% (w/v) and 6% (w/v), preferably between about 0.005% (w/v) and 5% (w/v), more preferably between about 0.05% (w/v) and 3% (w/v), and most preferably between about 0.5% (w/v) and 2% (w/v). About 1% (w/v) of citric acid is most preferred.

In a preferred embodiment, the growth media or incubation solution comprises sucrose, glucose, fructose, citric acid, carboxymethyl cellulose high V, carboxymethyl cellulose low V, pectin, yeast extract, peptone, calcium lactate pentahydrate, Tween 80, magnesium sulfate heptahydrate, and manganese sulfate monohydrate.

In embodiments in which microbial fermentation is carried out with either yeast or bacteria (but not both together), the fermentation may be carried out in the following growth media into which the microbes and legume (i.e. beans) are added and co-incubated.

Yeast & lactobacillus-LB Broth (Lennox) comprising NaCl, 5 g/L, Tryptone, 10 g/L, Yeast Extract, 5 g/L.

Acetobacter-AA broth was prepared by mixing the following ingredients: 1% (w/v) D-glucose, 1.5% (w/v) bacteriological peptone, and 0.8% (w/v) yeast extract. After sterilisation, 0.5% (v/v) ethanol and 0.3% (v/v) acetic acid were added to the mixture.

The growth media or incubation solution is preferably prepared by mixing the reagents and adjusting the pH.

Preferably, the growth media or incubation solution has an acidic pH. Preferably, the growth media or incubation solution has a pH of 1-6, 2-5 or 3-4. In a preferred embodiment, the growth media has a pH of about 3.6.

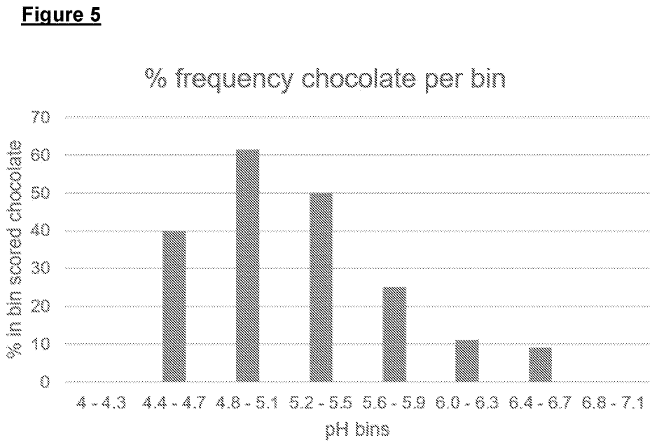

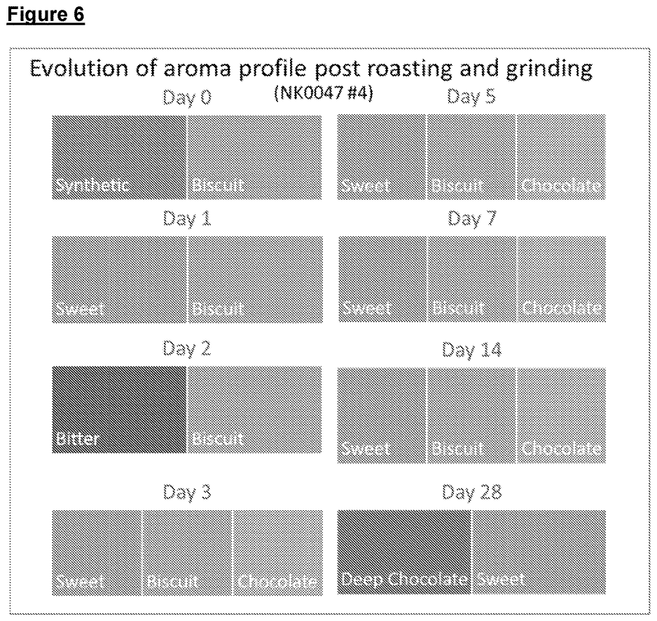

As described in the Examples, the inventors have found that good chocolate aroma analogues are associated with lower pH treated fava bean powder. Referring to FIG. 5, it is shown that a pH optimum for a chocolate aroma is pH 4.8-5.1. Furthermore, FIG. 6 shows that in chocolate analogues with a lower pH, a chocolate aroma starts to develop at day 3-4 after roasting and grinding, and is developed at day 7 and continues to improve for up to 1 month, after which it is stable for at least 4 months.

Preferably, the chocolate analogue has a pH of between about 4 and about 7, more preferably between about 4.3 and about 6.8, and more preferably between about 4.4 and about 6.7.

Preferably, the chocolate analogue has a pH of between about 4.4 and about 6.3, more preferably between about 4.7 and about 5.9, and more preferably between about 4.7 and about 5.5.

Preferably, the chocolate analogue has a pH of between about 4.4 and about 5.5, more preferably between about 4.7 and about 5.2. Most preferably, the chocolate analogue has a pH of between about 4.8 and about 5.1.

The media or incubation solution is then preferably autoclaved, and may then be stored at 4 deg C.

For microbial fermentation, the legume is preferably contacted with the at least one micro-organism for one or more days at a temperature suitable to sustain growth for the one of more micro-organism in order for the microbial fermentation to occur. Preferably, the microbial fermentation is allowed to take place for at least two, three, four or five days.

In embodiments in which the at least one micro-organism is a yeast, the microbial fermentation may be carried out a temperature of 21° C.-37° C., 23° C.-35° C., 24° C.-34° C., 26° C.-33° C., or 27° C.-32° C. Preferably, the microbial fermentation mixture is incubated at a temperature of about 30° C., which is optimum for yeast cell growth.

In embodiments in which the at least one micro-organism is a bacterium, however, the microbial fermentation may be carried out a temperature of 24° C.-50° C., 26° C.-48° C., 28° C.-46° C., 30° C.-44° C., or 32° C.-44° C., 34° C.-44° C., 36° C.-44° C., 38° C.-44° C., or 40° C.-44° C. Preferably, the microbial fermentation mixture is incubated at a temperature of about 42° C., which is optimum for bacterial cell growth.

It will be appreciated that when a combination of yeast and bacteria are grown together, a suitable temperature will be used, for example 24° C.-44° C., 26° C.-43° C., or 28° C.-42° C.

It will be appreciated that any of the temperatures described herein may be combined with any of the times described herein. Thus, for example, the microbial fermentation may comprise incubating yeast and bacteria at 24° C.-44° C. for at least 1 or 2 days. Alternatively, the microbial fermentation may comprise incubating yeast at 21° C.-37° C. for at least 1 or 2 days. Alternatively, the microbial fermentation may comprise incubating bacteria at 24° C.-50° C. for at least 1 or 2 days, and so on.

As described in the Examples, the inventors have demonstrated two different embodiments for the microbial fermentation of the legume to produce the cacao bean-free chocolate analogue, as illustrated in FIGS. 1B and 1C.

Thus, in one embodiment (shown in FIG. 1B), the microbial fermentation method may comprise simultaneously microbially fermenting the legume in the presence of yeast and bacteria. In this embodiment, preferably the yeast comprises Pichia kudriavzevii, Hanseniaspora opuntiae, and/or Saccharomyces cerevisiae, and most preferably Pichia kudriavzevii, Hanseniaspora opuntiae, and Saccharomyces cerevisiae. Preferably, the bacteria comprises Lactobacillus fermentum, Lactobacillus plantarum, and/or Acetobacter pasterianus, and most preferably Lactobacillus fermentum, Lactobacillus plantarum, and Acetobacter pasterianus. Preferably, the yeast and bacteria are mixed or pooled together, preferably with the concentration of each isolate being at least 1×10⁷ or 1×10⁸ cells/mL.

In the first embodiment (combined yeast and bacterial fermentation), the method comprises contacting the legume with yeast and bacterial cells for at least 24 hours at a temperature of 21° C.-37° C. Preferably, the microbial fermentation mixture is incubated at a temperature of 21° C.-37° C., 23° C.-35° C., 24° C.-34° C., 26° C.-33° C., or 27° C.-32° C. Preferably, the microbial fermentation mixture is incubated at a temperature of 30° C. Preferably, the microbial fermentation mixture is incubated for at least 36 or 48 hours.

Preferably, the method then comprises discarding the growth media after the one or more days of initial microbial fermentation. Preferably, the method comprises further incubating the legume and at least one micro-organism for one or more days at a temperature of 24° C.-50° C. Preferably, the microbial fermentation mixture is incubated at a temperature of 26° C.-48° C., 28° C.-46° C., 30° C.-44° C., 32° C.-44° C., 34° C.-44° C., 36° C.-44° C., 38° C.-44° C., or 40° C.-44° C. Preferably, the microbial fermentation mixture is incubated at a temperature of 42° C. Preferably, the mixture is incubated for at least two or three days. Preferably, the microbial fermentation mixture is incubated for three days. It will be appreciated that any of the temperatures described herein may be combined with any of the times described herein. At the end of the microbial fermentation process, the method preferably comprises drying the legume. The dried legume may then be processed to create a suitable substrate with which a foodstuff may be prepared, as described later.

In a second embodiment (shown in FIG. 1C), the method may comprise initially microbially fermenting the legume in the presence of only yeast, and then subsequently in the presence of bacteria (and yeast). In this embodiment, preferably the yeast comprises Pichia kudriavzevii, Hanseniaspora opuntiae, and/or Saccharomyces cerevisiae, and most preferably Pichia kudriavzevii, Hanseniaspora opuntiae, and Saccharomyces cerevisiae. Preferably, the bacteria comprises Lactobacillus fermentum, Lactobacillus plantarum, and/or Acetobacter pasterianus, and most preferably Lactobacillus fermentum, Lactobacillus plantarum, and Acetobacter pasterianus. Preferably, the yeast and bacteria are kept separate in separate pools, with the concentration of each being at least 1×10⁷ or 1×10⁸ cells/mL.

In the second embodiment (initial yeast only fermentation followed by yeast and bacterial fermentation), the method comprises contacting the legume with yeast cells for at least 24 hours at a temperature of 21° C.-37° C. Preferably, the microbial fermentation mixture is incubated at a temperature of 21° C.-37° C., 23° C.-35° C., 24° C.-34° C., 26° C.-33° C., or 27° C.-32° C. Preferably, the microbial fermentation mixture is incubated at a temperature of 30° C. Preferably, the microbial fermentation mixture is incubated for at least 36 or 48 hours.

Preferably, the method then comprises discarding the growth media after the one or more days of initial microbial fermentation. Preferably, the method comprises contacting the fermented legume with bacterial cells for at least 24 hours at a temperature of 24° C.-50° C. Preferably, the microbial fermentation mixture is incubated at a temperature of 26° C.-48° C., 28° C.-46° C., 30° C.-44° C., 32° C.-44° C., 34° C.-44° C., 36° C.-44° C., 38° C.-44° C., or 40° C.-44° C. Preferably, the microbial fermentation mixture is incubated at a temperature of 42° C. Preferably, the mixture is incubated for at least two or three days. Preferably, the microbial fermentation mixture is incubated for three days. It will be appreciated that any of the temperatures described herein may be combined with any of the times described herein.

At the end of the microbial fermentation process, the method preferably comprises drying the legume. The dried legume may then be processed to create a suitable substrate with which a foodstuff may be prepared, as described later.

In a third embodiment (not shown), the method may comprise initially microbially fermenting the legume in the presence of only bacteria, and then subsequently in the presence of yeast (and bacteria). In this embodiment, preferably the yeast comprises Pichia kudriavzevii, Hanseniaspora opuntiae, and/or Saccharomyces cerevisiae, and most preferably Pichia kudriavzevii, Hanseniaspora opuntiae, and Saccharomyces cerevisiae. Preferably, the bacteria comprises Lactobacillus fermentum, Lactobacillus plantarum, and/or Acetobacter pasterianus, and most preferably Lactobacillus fermentum, Lactobacillus plantarum, and Acetobacter pasterianus. Preferably, the yeast and bacteria are kept separate in separate pools, with the concentration of each being at least 1×10⁷ or 1×10⁸ cells/mL.

In the third embodiment (initial bacterial only fermentation followed by bacterial and yeast fermentation), contacting the legume with bacterial cells for at least 24 hours at a temperature of 24° C.-50° C. Preferably, the microbial fermentation mixture is incubated at a temperature of 26° C.-48° C., 28° C.-46° C., 30° C.-44° C., 32° C.-44° C., 34° C.-44° C., 36° C.-44° C., 38° C.-44° C., or 40° C.-44° C. Preferably, the microbial fermentation mixture is incubated at a temperature of 42° C. Preferably, the mixture is incubated for at least two or three days. Preferably, the microbial fermentation mixture is incubated for three days.

Preferably, the method then comprises discarding the growth media after the one or more days of initial microbial fermentation. Preferably, the method comprises contacting the microbially fermented legume with yeast cells for at least 24 hours at a temperature of 21° C.-37° C. Preferably, the microbial fermentation mixture is incubated at a temperature of 21° C.-37° C., 23° C.-35° C., 24° C.-34° C., 26° C.-33° C., or 27° C.-32° C. Preferably, the microbial fermentation mixture is incubated at a temperature of 30° C. Preferably, the microbial fermentation mixture is incubated for at least 36 or 48 hours. It will be appreciated that any of the temperatures described herein may be combined with any of the times described herein. At the end of the microbial fermentation process, the method preferably comprises drying the legume. The dried legume may then be processed to create a suitable substrate with which a foodstuff may be prepared, as described later.

In the embodiment in which the method comprises non-microbial fermentation, the method comprises use of
an incubation medium having a pH of between 3 and 5 (preferably about 3.6), and so incubation in this medium will tend to acidify the legume (preferably the fava bean). Further, the complete submergence of the legume (e.g. fava beans) as they start to germinate will rapidly consume the available oxygen for respiration. Under anoxic conditions, fermentative metabolism is initiated with the oxidation of sugars leading to the production of ethanol, lactic acid and possibly acetic acid. Accumulation of lactic and acetic acid could further reduce the pH of the legume (preferably fava bean).

Preferably, the non-microbial fermentation mixture is incubated at a first temperature of 20° C.-38° C., 23° C.-37° C., 24° C.-36° C., 25° C.-35° C., 26° C.-34° C., 27° C.-33° C., 28° C.-32° C., or 29° C.-31° C. Preferably, the non-microbial fermentation mixture is incubated at a temperature of 30° C. Preferably, the mixture is incubated for at least one or two days. Preferably, the non-microbial fermentation mixture is incubated for two days.

Preferably, the non-microbial fermentation mixture is incubated at a second temperature of 26° C.-48° C., 28° C.-46° C., 30° C.-44° C., 32° C.-44° C., 34° C.-44° C., 36° C.-44° C., 38° C.-44° C., or 40° C.-44° C. Preferably, the non-microbial fermentation mixture is incubated at a temperature of 42° C. Preferably, the mixture is incubated for at least one, two or three days. Preferably, the non-microbial fermentation mixture is incubated for three days.

In a preferred embodiment, the method comprises drying the legume after microbial or non-microbial fermentation. Preferably, the legume is dried with heat in an oven. Preferably, the legume is dried in the oven for one or more days at a temperature of about 21° C.-37° C. Preferably, the legume is dried in the oven at a temperature of, 23° C.-35° C., 25° C.-40° C., 28° C.-38° C., or 30° C.-36° C. During this period, beans are mixed on drying days 1, 2, and 3 to minimize bean clumping. Preferably, the legume is dried in the oven at a temperature of 35° C. Preferably, drying is carried out for two, three, four, five, six or seven days. Preferably, the legume is dried in the oven for seven days.

In an embodiment, the cacao bean-free chocolate analogue comprising a microbially and/or non-microbially legume may comprise a solid, liquid or powder.

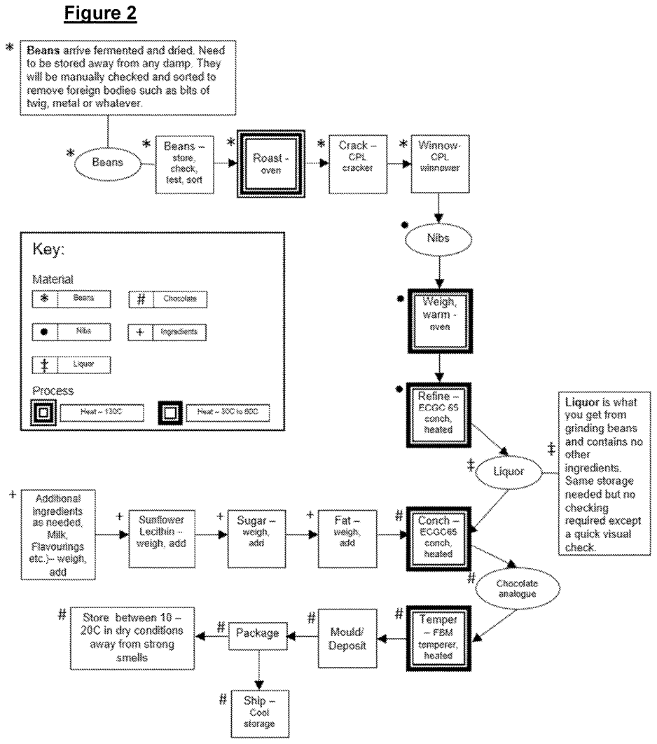

In one embodiment, the cacao bean-free chocolate analogue comprising a microbially and/or non-microbially fermented legume may comprise or be converted into a paste. FIG. 2 shows an embodiment as to how a paste can be prepared from the fermented legume.

Preferably, therefore, the method comprises roasting the microbially and/or non-microbially fermented legume. Preferably, the method comprises cracking and winnowing the roasted legume to form a plurality of nibs. Preferably, the method comprises refining and conching the plurality of nibs so as to form a non-cocoa chocolate liquor. Preferably, the method comprises adding one or more additive to the non-cocoa chocolate liquor. It will be appreciated that, when using authentic cocoa beans, grinding roasted bean leads to the production of a thick liquid/paste called a “liquor”. This is because cocoa beans contain approximately 40% fat (called “cocoa butter”). However, fava beans are very low in fat. So, when the treated fava beans of the invention are roasted and ground, a powder (not a liquid) is produced. To create a ‘liquor’ from the fava bean powder, a fat with similar properties to cocoa butter (e.g. shea butter) may be added.

Preferably, the method comprises repeating the previous step on the non-cocoa chocolate liquor to thereby produce a non-cocoa chocolate analogue paste.

Preferably, the method comprises tempering the non-cocoa chocolate analogue paste. Preferably, the method comprises moulding the tempered non-cocoa chocolate analogue paste.

In one embodiment, roasting the microbially or non-microbially fermented legume comprises heat-treating the legume at at least 150° C. for at least 1 minute. Preferably, roasting the fermented legume comprises heat-treating the legume at at least 170° C., 190° C., or 210° C., more preferably at least 220° C., 240° C., or 250° C. Preferably, roasting the fermented legume comprises heat-treating the legume at less than 350° C., 330° C., or 310° C., more preferably less than 300° C., 290° C., or 280° C. Preferably, roasting the fermented legume comprises heat-treating the legume at between 15° and 350° C., more preferably between 18° and 280° C. Preferably, roasting is carried out for at least 2, 3 or 4 minutes, more preferably at least 5, 6 or 7 minutes. Preferably, roasting is carried out for between 5 and 20 minutes at between 18° and 280° C. It will be appreciated that any of the temperatures described herein may be combined with any of the times described herein.

In another embodiment, the cracking of the legume is performed in a mechanical or electrical cracker. In another embodiment, the winnowing of the legume is performed in a mechanical or electrical winnower.

In one embodiment, the cracking and the winnowing of the legume are performed simultaneously. In one embodiment, the cracking and the winnowing of the legume are performed sequentially. In a preferred embodiment, the cracking of the legume is performed prior to the winnowing of the legume.

In one embodiment, the plurality of nibs are pre-heated prior to the refining and conching step. In another embodiment, the plurality of nibs are not pre-heated prior to the refining and conching step.

In one embodiment, refining and conching the fermented legume comprises heat treating the legume in conching machine.

In another embodiment, tempering the fermented legume comprises heat treating the legume in a tempering machine.

In yet another embodiment, the non-cocoa chocolate analogue paste is stored at a temperature ranging between 5° C.-25° C.; 7° C.-23° C. or 7° C.-23° C. Preferably, non-cocoa chocolate analogue paste is stored at a temperature ranging between 10° C.-20° C.

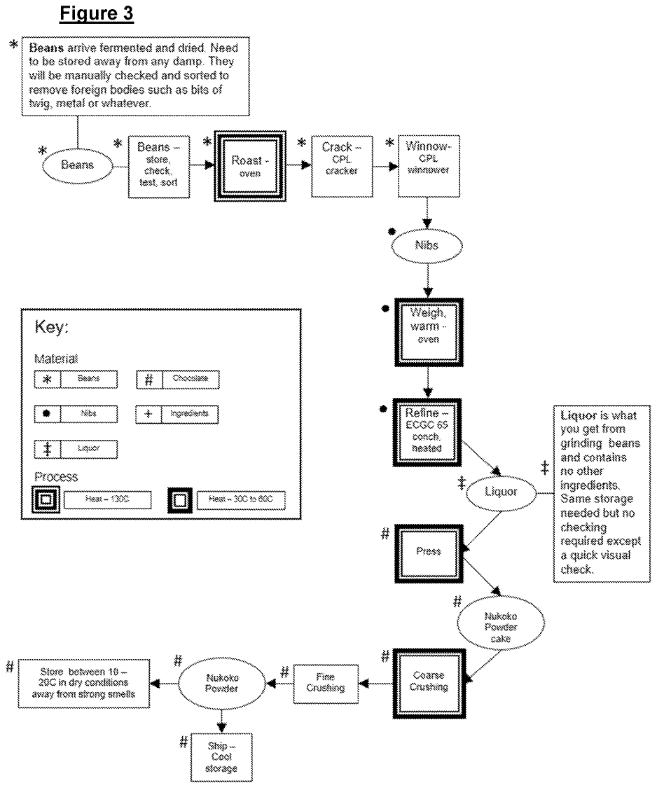

In an alternative embodiment, however, the cacao bean-free chocolate analogue comprising a microbially and/or non-microbially legume may comprise a powder. FIG. 3 shows an embodiment as to how a powder can be prepared from the fermented legume. In an alternative embodiment, however, the cacao bean-free chocolate analogue comprising a microbially and/or non-microbially legume may comprise a liquor.

In an alternative embodiment, the cacao bean-free chocolate analogue comprising microbially and/or non-microbially fermented fava bean which is preferably combined with cacao bean-free chocolate analogue comprising non-microbially fermented non-fava bean legume.

In another alternative embodiment, however, the cacao bean-free chocolate analogue comprising microbially and/or non-microbially fermented fava bean which is preferably combined with cacao bean-free chocolate analogue comprising microbially fermented non-fava bean legume.

The non-fava bean legume may be any of those described herein.

Preferably, the method comprises roasting a microbially or non-microbially fermented legume. Preferably, the method comprises cracking and winnowing the legume to form a plurality of nibs. Preferably, the method comprises refining and conching the plurality of nibs so as to form a non-cocoa chocolate liquor. Preferably, the method comprises pressing the non-cocoa chocolate liquor so as to form a non-cocoa chocolate powder cake. Preferably, the method comprises grinding the non-cocoa chocolate powder cake thereby producing non-cocoa chocolate analogue powder.

In one embodiment, roasting the microbially or non-microbially fermented legume comprises heat-treating the legume at at least 150° C. for at least 1 minute. Preferably, roasting the fermented legume comprises heat-treating the legume at at least 170° C., 190° C., or 210° C., more preferably at least 220° C., 240° C., or 250° C.

Preferably, roasting the fermented legume comprises heat-treating the legume at less than 350° C., 330° C., or 310° C., more preferably less than 300° C., 290° C., or 280° C. Preferably, roasting the fermented legume comprises heat-treating the legume at between 15° and 350° C., more preferably between 18° and 280° C. Preferably, roasting is carried out for at least 2, 3 or 4 minutes, more preferably at least 5, 6 or 7 minutes. Preferably, roasting is carried out for between 5 and 20 minutes at between 18° and 280° C. It will be appreciated that any of the temperatures described herein may be combined with any of the times described herein.

In another embodiment, the cracking of the legume is performed in a mechanical or electrical cracker. In another embodiment, the winnowing of the legume is performed in a mechanical or electrical winnower.

In one embodiment, the cracking and the winnowing of the legume are performed simultaneously. In one embodiment, the cracking and the winnowing of the legume are performed sequentially. In a preferred embodiment, the cracking of the legume is performed prior to the winnowing of the legume.

In one embodiment, the plurality of nibs are pre-heated prior to the refining and conching step. In another embodiment, the plurality of nibs are not pre-heated prior to the refining and conching step.

In one embodiment, grinding the non-cocoa chocolate powder cake first coarse grinding and subsequently fine grinding the non-cocoa chocolate powder cake.

In yet another embodiment, the non-cocoa chocolate analogue powder is stored at a temperature ranging between 5° C.-25° C.; 7° C.-23° C. or 7° C.-23° C. Preferably, non-cocoa chocolate analogue paste is stored at a temperature ranging between 10° C.-20° C.

The inventors have shown that it is possible to prepare a variety of different foodstuffs, solid or liquid, using the cacao bean-free chocolate analogue described herein.

Thus, in a fifth aspect, there is provided a product ingredient comprising the cacao bean-free chocolate analogue according to the first, second or fourth aspect.

Thus, in a sixth aspect, there is provided a foodstuff or beverage comprising the cacao bean-free chocolate analogue according to the first, second or fourth aspect, or the ingredient of the fifth aspect.

The cacao bean-free chocolate analogue may be a powder, liquor, liquid, solid, or in a paste form.

The roasted and ground fava beans may produce a dry powder. This dry powder may have fat added (e.g. shear butter) to create a solid which liquifies when warmed to 31-38° C., if shea butter is used. This liquid is equivalent to the liquid produced when a cocoa bean is ground up, but for cocoa, no fat needs to be added.

The foodstuff is preferably a confectionary product. For example, the foodstuff may be a block bar, moulded figure, button, truffle, spread, coated fruit, nuts and other inners, bakery filling, coating on a product, such as a donut or muffin, yoghurt, ice cream or other dessert. The beverage may be a hot drink or cold drink.

In a seventh aspect, there is provided a cosmetic product comprising the cacao bean-free chocolate analogue according to the first, second or fourth aspect, or the ingredient of the fifth aspect.

The cosmetic may be a skin care product, such as a moisturizer, an exfoliator, lip balm, eye shadow, soap, body cream or butter, or a hair mask.

All of the features described herein (including any accompanying claims, abstracts and drawings), and/or all of the steps of any method or process so disclosed, may be combined with any of the above aspects in any combination, except combinations where at least some features and/or steps are mutually exclusive.

For a better understanding of the invention, and to show how embodiments of the same may be carried into effect, reference will now be made, by way of example, to the accompanying Figures, in which:—

FIG. 1 shows a schematic overview of legume fermentation according to two embodiments of the invention. First, a fermentation inoculum is prepared from a single colony of a yeast or bacterium as shown in FIG. 1A. The colony is grown in a selective medium and the preparation of the grown microorganism cells are pooled in a vial and stored until the fermentation process. Two types of fermentation inoculums are prepared, one that contains both yeast and bacteria (option 1), and the second type fermentation inoculum comprises either yeast only or bacteria only (option 2). FIG. 1B shows an exemplary legume fermentation process according to the invention in which the fermentation inoculum according to option 1 is used, and FIG. 1C shows an exemplary legume fermentation process according to the invention in which the fermentation inoculum according to option 2 is used. FIG. 1D shows a further exemplary legume fermentation processing according to the invention, in which two separate reactions are carried out which are microbial and non-microbial treatment of the legume. Firstly, the legume is treated by micro-organisms (either option 1 or option 2), to produce a microbially fermented legume, and then, separately, the legume is treated in the absence of any micro-organisms to produce non-microbially treated legume. Then, a proportion of the microbially fermented legume and a proportion of the non-microbially treated legume is blended or mixed together to result in cacao bean-free chocolate analogue.

FIG. 2 shows a schematic overview of an embodiment of a method for making a chocolate analogue paste.

FIG. 3 shows a schematic overview of an embodiment of a method for making a chocolate analogue powder.

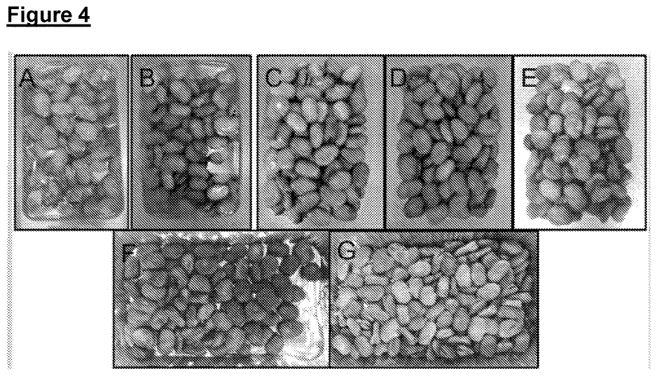

FIG. 4 shows photographs of dried fava beans after 3 hr rehydration. (a) 0 hr, (b) 24 hr incubation, (c) 48 hr incubation, (d) 72 hr incubation, (e) 120 hr incubation, (f) dried beans after 120 hr fermentation, (g) dried unfermented beans.

FIG. 5 shows a bar graph of the percentage frequency of chocolate aroma per bin, and thereby the optimum pH of roasted fava bean powders to produce the best chocolate aroma.

FIG. 6 shows the development of aroma profiles after bean roasting and grinding over time.

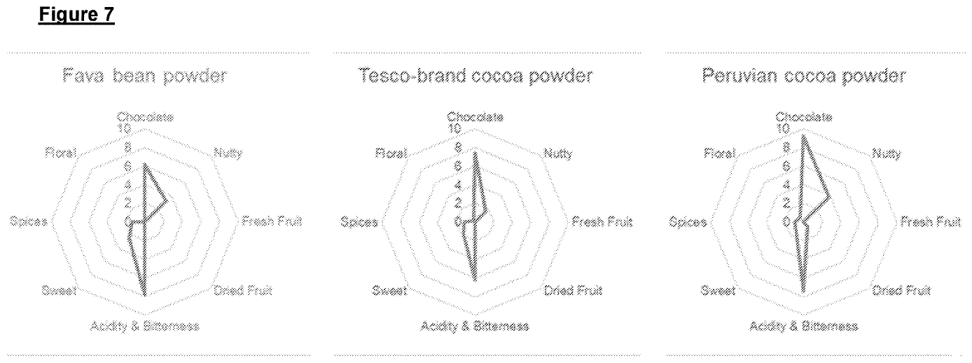

FIG. 7 shows the flavour profiles of liquors (powder+shea butter 1:1 w/w) scored by five independent assessors; the fava bean powder is representative of powder produced from ten independent bean preparations. As can be seen, the Fava bean powder of the invention shows very similar flavour properties to the supermarket (Tesco) cocoa powder and Peruvian cocoa powder.

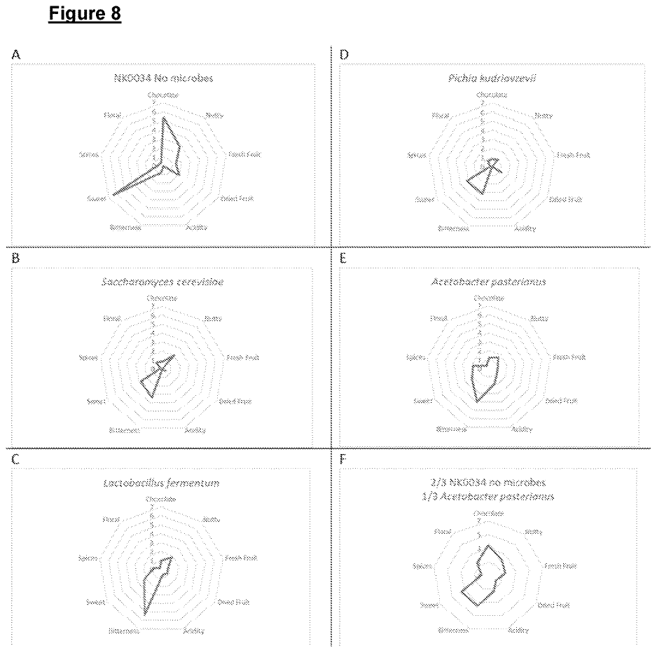

FIG. 8 shows the flavour profiles for liquors (bean powder, sugar and shea butter) made from processed roasted and ground fava bean powder are shown, with fava beans (NK0034) treated using our non-microbial process included for comparison. Flavour evaluated by 5 independent individuals.

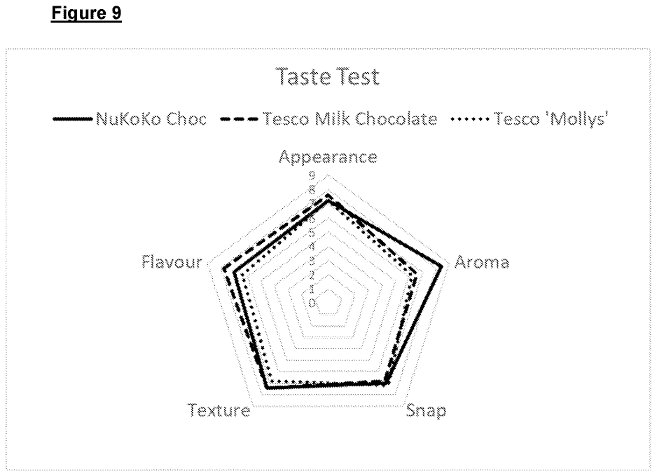

FIG. 9 shows the flavour profile of the chocolate analogue according to the invention (referred to herein as “NuKoKo choc”) and authentic supermarket Tesco-brand Milk Chocolate and Dark Chocolate (Mollys). Flavour was evaluated by 5 independent individuals.

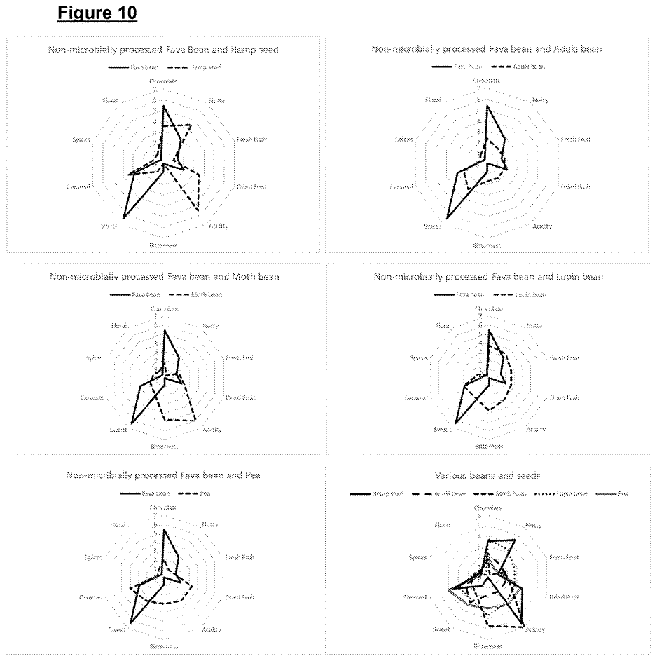

FIG. 10 shows the flavour profiles for liquors (bean powder, sugar and shea butter) made from processed roasted and ground fava beans, and a selection of other beans and seeds, all treated using the non-microbial process of the invention. (A) Hemp seed, (B) Aduki bean, (C) Moth bean, (D) Lupin bean, (E) Pea. Fava bean (NK0034) is shown for comparison (A, B, C, D, E). (F) All non-fava beans and seeds groups for comparison. Flavour was evaluated by 3 independent individuals.

### EXAMPLES

Fermentation is an essential step required for cacao/cocoa beans to develop the characteristic and distinctive chocolate flavour and aroma. In order to develop non-cocoa chocolate alternatives, the inventors have first identified various legumes presenting key characteristics that they believed to provide traditional chocolate with its distinctive consistency, flavour, colour and aroma, and subsequently selected a subset of legumes that meet the required profile. The inventors have also developed and highly optimised a fermentation process (both in the presence and absence of certain micro-organisms, such as yeast and bacteria) applied to the selected legumes (e.g. the Fava bean), which give to the cocoa analogue powder made from these legumes, the same characteristics (in terms of taste and aroma) of normal cocoa powder. The fermented legume may then be processed to prepare a chocolate analogue, from which various foodstuffs can be formed.

In a first embodiment, as shown in FIGS. 1B and 1C, the process involves microbial fermentation treatment of the legume, such as Fava bean. Two types of fermentation inoculums are prepared, one that contains both yeast and bacteria (option 1), and the second type fermentation inoculum comprises either yeast only or bacteria only (option 2). FIG. 1B shows an exemplary legume fermentation process in which the fermentation inoculum according to option 1 is used to result in the cacao bean-free chocolate analogue, and FIG. 1C shows an exemplary legume fermentation process in which the fermentation inoculum according to option 2 is used to result in the cacao bean-free chocolate analogue.

In a second embodiment, as shown in FIG. 1D, two separate treatments of the legume (e.g. Fava bean). Firstly, the legume is treated by micro-organisms (either option 1 or option 2), to produce a microbially fermented legume. Secondly, and separately, the legume is treated in the absence of any micro-organisms to produce non-microbially treated legume. Subsequently, a proportion of the microbially fermented legume is blended with a proportion of the non-microbially treated legume to result in the cacao bean-free cocoa powder analogue.

### Materials and Methods

### Selection of Legume Candidates

The inventors initially set out specific selective criteria for legumes to be considered for a further testing phase and those included crops that are low cost, agriculturally well-established and grown comparatively close to production facilities (in particular, in Europe). From the inventor's extensive research, the following attributes were then identified to be essential for legume candidates to exhibit chocolate characteristics (taste and aroma) post fermentation. These attributes include:
1) A sufficient content of 7S VCG (vicilin 7S class globulin) proteins or a homologue thereof.
2) A readily utilisable source of carbohydrate, to overcome the drawbacks associated with reducing sugar content during fermentation.
3) High content of flavan-3-ols and procyanidins to enhance chocolate-like flavour and colour development.

For legume candidates that only meet the first attribute, pre-enrichment of the legumes before fermentation with a suitable food-grade source of sugar and flavan-3-ols and procyanidins, such as apple or grape juice, was implemented.

### Legume Fermentation

### Materials

Unless otherwise stated, the chemicals and plastic consumables used for the fermentation of the selected legumes were purchased from Sigma-Aldrich and Scientific Laboratory Supplies Ltd. All solutions were prepared using reverse osmosis (RO) water.

### Sterilisation

The solutions and consumables used in the invention were heat-sterilized by autoclaving for 15 min at 121° C. (130 kPa).

### Step 1: Preparation of a Synthetic Pulp (Microbial Fermentation Growth Media)

A synthetic pulp was prepared by mixing the following ingredients: 2.5% (w/v) sucrose (catalogue number: S0389-1 KG)
4% (w/v) glucose (catalogue number: G7021-5 KG)
5% (w/v) fructose (catalogue number: F0127-1 KG)
1% (w/v) citric acid (catalogue number: C0759-1 KG)
0.14% (w/v) carboxymethyl cellulose high V (catalogue number: C5678-1 KG)
0.77% (w/v) carboxymethyl cellulose low V (catalogue number: C5013-1 KG)
1.09% (w/v) pectin (catalogue number: P9135-500G)
0.5% (w/v) yeast extract (catalogue number: 70161-500G)
0.5% (w/v) peptone (catalogue number: 91249-500G)
0.1% (w/v) calcium lactate pentahydrate (catalogue number: C8356-250G)
0.1% (v/v) Tween 80 (catalogue number: P4780-100ML)
0.05% (w/v) magnesium sulfate heptahydrate (catalogue number: M2773-1 KG)
0.02% (w/v) manganese sulfate monohydrate (catalogue number: M7899-500G)

The pH of mixture of the above ingredients was then adjusted to pH of 3.6 to create a suitable growth media for the yeast and bacteria, such that the micro-organisms fermented the legume. The mixture was then sterilised as described above and then stored at 4° C.

### Step 2: Preparation of the Selective Agar and Broth (Inoculum Growth Media)

The following agar media were used:

### Acetic Acid (AA) Agar

The AA agar was prepared by mixing the following ingredients: 1% (w/v) D-glucose, 1.5% (w/v) bacteriological peptone, 0.8% (w/v) yeast extract, and 2% (w/v) agar. The mixture was then sterilised as described above. After sterilisation, 0.5% (v/v) ethanol and 0.3% (v/v) acetic acid were added to the mixture and final pH of the mixture adjusted to 4.5.

### Acetic Acid (AA) Broth

The AA broth was prepared by mixing the following ingredients: 1% (w/v) D-glucose, 1.5% (w/v) bacteriological peptone, and 0.8% (w/v) yeast extract. The mixture was then sterilised as described above. After sterilisation, 0.5% (v/v) ethanol and 0.3% (v/v) acetic acid were added to the mixture.

### De Man Rogosa Sharpe (MRS) Agar:

The MRS agar (catalogue number: 69964-500G) was prepared according to the manufacturer's instructions. In summary, 61.15 g of MRS agar were added to 800 ml of RO water containing 1 ml TWEEN 80 (catalogue number: P8074). The suspension was then boiled until the medium was completely dissolved, and the total volume was adjusted to 1000 ml. The mixture was then sterilised as described above.

### Yeast Peptone Glucose (YPG) Agar:

The YPG agar was prepared by mixing the following ingredients: 1% (w/v) yeast extract, 2% (w/v) peptone, 2% (w/v) glucose. The pH of the mixture was adjusted to 5.6, then 2% (w/v) agar was added. The solution was then sterilised as described above.

### Micro-Organisms

The inventors have identified six microorganisms (yeasts and bacteria) that displayed optimal fermentation results for the selected legumes. These include: Pichia kudriavzevii, Hanseniaspora opuntiae, Saccharomyces cerevisiae, Lactobacillus fermentum, Lactobacillus plantarum, and Acetobacter pasterianus. The inventors have further observed that each of the microorganisms were selected on specific agar mediumas summarised in the table below:

TABLE 1
Selective agar for each of the microorganism

| Microorganism | Selective agar |
|---|---|
| Pichia kudriavzevii | YPG |
| Hanseniaspora opuntiae | YPG |
| Saccharomyces cerevisiae | YPG |
| Lactobacillus fermentum | MRS |
| Lactobacillus plantarum | MRS |
| Acetobacter pasterianus | AA |

### Step 3: Preparation of the Fermentation Inoculum

To prepare the fermentation inoculum, the following steps performed under sterile conditions:
1. The selective agar were prepared as described above and poured into sterile 9 cm petri dishes (20 ml each) and allowed to cool and harden.
2. Glycerol stocks of each microorganism were plated on their respective selective agar plate (as described in Table 1) and incubated at 28° C. for 72 hours.
3. For each isolate, 15 mL tubes containing 3 mL of Luria broth Lennox was prepared, except for Acetobacter pasterianus which requires a 15 ml tube containing 3 mL of AA broth. The tubes were then sterilised as described above. For the AA broth, the 0.5% (v/v) ethanol and 0.3% (v/v) acetic acid were added to the tube after sterilisation.
4. A single colony from the agar plate was selected for each isolate and transferred to the 3 ml of the respective growth media and incubated at 28° C. at 200 rpm in a shaking incubator for 72 hours.
5. Cells were harvested by centrifuging at 4,000× rpm at 4° C. for 8 minutes.
6. The supernatant was discarded and 5 ml of sterile 10 mM MgCl₂ added to the tubes.
7. The tubes were inverted 10 times to resuspend the pelleted cells and then centrifuged at 4,000× rpm at 4° C. for 8 minutes.
8. Steps 6-7 were repeated two more times for a total of three washes.
9. Finally, cells were resuspended in 1 mL sterile 10 mM MgCl₂ and the optical density at 600 nm (OD600) measured for each isolate (1 OD 600=1×10⁹ cells/mL) to determine cell concentrations.
10. Once the microorganisms were purified, two distinct fermentation inoculums were prepared as follows:

### Option 1 (Combined Yeast and Bacteria)

All purified yeast (Pichia kudriavzevii, Hanseniaspora opuntiae, and Saccharomyces cerevisiae) and bacterial (Lactobacillus fermentum, Lactobacillus plantarum, and Acetobacter pasterianus) isolates were pooled together, with the concentration of each isolate being 1×10⁸ cells/mL (sterile 10 mM MgCl₂ was used to dilute the cells when necessary).

### Option 2 (Only Yeast or Only Bacteria)

The yeast isolates (Pichia kudriavzevii, Hanseniaspora opuntiae, and Saccharomyces cerevisiae) were combined together and the bacterial isolates (Lactobacillus fermentum, Lactobacillus plantarum, and Acetobacter pasterianus) were combined together and each group was pooled into separate pools, with the concentration of each isolate being 1×10⁸ cells/mL (sterile 10 mM MgCl₂ was used to dilute the cells when necessary).

For each option, 1 mL of inoculum was prepared and stored at 4° C. for no longer than 24 hours.

### Step 4: Legume Fermentation

To ferment the legumes, two distinct protocols were designed based on whether the fermentation inoculum of option 1 was used (protocol 1 in FIG. 1B) or the fermentation inoculum of option 2 was used (protocol 2 in FIG. 1C). The protocols comprise the following steps performed under sterile conditions:

### Sterilization and Rehydration of Beans

Selected beans (see below for selection criteria) were fermented as follows. For each fermentation replicate, 125 g of beans were weighed out using an analytical balance and transferred to a 500 mL reagent glass bottle. Weight of beans and volumes of solutions can be scaled as required to produce more or less material.
1. Bean sterilization solution (70% ethanol, 0.05% Triton X-100 (catalogue number: T8787-250ML)) prepared (100 mL for each fermentation replicate).
2. Sterilization solution added to the beans and agitated at 200 rpm and 25° C. for 30 min using an orbital shaker.

The following steps are performed under sterile conditions.
3. Sterilization solution discarded using a sterile 25 mL disposable polystyrene serological pipette.
4. Beans subsequently washed by adding 250 ml of sterile RO water to the bottle, mixed by inverting the bottle 10 times and discarding the wash.
5. Step 5 was repeated two more times for a total of three washes.
6. Sterile RO water (250 mL) added to the bottle and beans incubated at 25° C. for 3 hr to rehydrate. Rehydration timing can be increased to further hydrate the beans either at 4° C., or at 25° C. to promote the germination processes.
7. Alternatively, beans can be pre-enriched ahead of fermentation with a suitable food-grade sources of sugar and flavan-3-ols/procyanidins (e.g. apple or grape juice), by including these in the rehydration solution.

### Protocol 1 (Combined Microbial Fermentation)

1. The beans were first rehydrated in water as described above.
2. Excess rehydration water was discarded and the beans were transferred to a sterile SacO2 microbox (catalogue number: TP1600+TPD1600 #30 WH).
3. 100 ml of the synthetic pulp prepared as described above were added to the beans in the microbox, followed by 1 mL of the pooled fermentation inoculum containing both the yeast and bacterium isolates (fermentation inoculum of option 1).
4. The beans, the synthetic pulp and the fermentation inoculum were mixed and the fermentation box was closed with the filtered lid and incubated at 30° C.
5. After 48 hours, the synthetic pulp was discarded and the beans were mixed.
6. The beans were then incubated for an additional 72 hours at 42° C., for a total incubation of 120 hours (FIG. 1B).

### Protocol 2 (Sequential Microbial Fermentation: Yeast Followed by Bacteria)

1. The beans were first rehydrated in water as described above.
2. Excess rehydration water was discarded and the beans were transferred to a sterile SacO2 microbox (catalogue number: TP1600+TPD1600 #30 WH).
3. 100 ml of the synthetic pulp prepared as described above were added to the beans in the microbox, followed by 1 mL of the pooled fermentation inoculum containing the yeast isolates only.
4. The beans, the synthetic pulp and the fermentation inoculum were mixed and the fermentation box was closed with the filtered lid and incubated at 30° C.
5. After 48 hours, the synthetic pulp was discarded and 1 mL of the pooled fermentation inoculum containing the bacterial isolates only was added to the beans (fermentation inoculum of option 2), and then the beans were stirred.
6. The beans were then incubated for an additional 72 hours at 42° C. (FIG. 1C).

### Step 5: Drying the Legume

Once the fermentation process was completed, the beans were laid out on foil trays and placed in an oven at 35° C. for 7 days to reduce the bean moisture content to less than 7% and control the acidity of the bean. During this period, beans were stirred on drying days 1, 2, and 3 to minimize bean clumping.

### Methods for Neutralising the Chocolate Analogue's Acidity, Enhance the Colour and Produce a Mild Flavour

‘Dutching’ is carried out by washing the cocoa powder with a potassium carbonate solution. The solution neutralises the powder's acidity to a pH of about 7, and gives it a rich dark brown colour. Dutched powder tends to have a milder, more earthy flavour than natural powder.

### Addition of the Lipid Fraction to the Cocoa Analogue

In traditional chocolate made of cocoa beans, the lipid fraction of the cocoa beans, although vital for the physical characteristics of chocolate, does not change significantly during fermentation, and does not appear to directly contribute to the flavour and aroma profile of the resulting chocolate. In view of the above and given that legumes are generally low in fat compared to cocoa beans, a lipid fraction (including standard cocoa butter replacement and/or extension) was added to the cocoa analogue of the invention to produce a chocolate analogue. Examples of other fats that can be used are shea butter, palm and coconut, and fats based on rapeseed oil.

### Addition of the Sweeteners to the Chocolate Analogue

Beet or cane sugar is used, as well as coconut sugars. In addition, non-sugars can be used that give more health benefits that are derived from other food fibres.

### Addition of Flavourings to the Chocolate Analogue

Some brands of caramel or vanilla can be added to the base flavour. Any type of flavour can be added to create an end consumer product, such as orange, mint, etc.

### Results

### Example 1: Selection of the Legume Candidates

The inventors have identified a number of legume candidates that met the preliminary requirements of low cost, agriculturally well-established and grown comparatively close to production facilities; these include: adzuki bean (phaseolus angularis), alfalfa (Medicago sativa), bambara (vigna subterranean), black gram: (vigna mungo), chickpea (Cicer arietinum), cowpea (vigna unguiculata), fava bean (Vicia faba), common bean (Phaseolus vulgaris), lima bean (Phaseolus lunatus), lentils (lens culinaris or Lens esculenta), lupins (lupinus albus, lupinus angustifolius, or lupinus luteus), moth bean (vigna aconitifolia), mung bean (vigna radiate), pea (Pisum sativum), pigeon pea (cajanus cajan), sesame (Sesamum indicum), scarlett runner bean (Phaseolus coccineus), soy (glycine max), and vetch (Vicia sativa).

Subsequently, the inventors identified their physico-chemical compositions based on the data provided by the United States Department of Agriculture (USDA). The data for each of the legumes are summarised in the table below:

TABLE 2
Approximate values for raw legume beans (per 100 g, USDA 2022)

| Food Data | | | | | Carbohydrate | | |
|---|---|---|---|---|---|---|---|
| Central Entry | | | | | (by | | |
| (bean type) | Water | Protein | Lipid | Ash | difference) | Fibre | Sugars |
| Adzuki beans, | 13.4 | 19.9 | 0.53 | 3.26 | 62.9 | 12.7 | — |
| mature seeds, | | | | | | | |
| raw | | | | | | | |
| Broadbeans | 11 | 26.1 | 1.53 | 3.08 | 58.3 | 25 | 5.7 |
| (fava beans), | | | | | | | |
| mature seeds, | | | | | | | |
| raw | | | | | | | |
| Black turtle | 11 | 21.2 | 0.9 | 3.6 | 63.2 | 15.5 | 2.12 |
| beans, mature | | | | | | | |
| seeds, raw | | | | | | | |
| Chickpeas | 7.68 | 20.5 | 6.04 | 2.85 | 63 | 12.2 | 10.7 |
| (garbanzo | | | | | | | |
| beans, bengal | | | | | | | |
| gram), mature | | | | | | | |
| seeds, raw | | | | | | | |
| Cowpeas, | 11 | 23.8 | 2.07 | 3.39 | 59.6 | 10.7 | — |
| catjang, | | | | | | | |
| mature seeds, | | | | | | | |
| raw | | | | | | | |
| Cowpeas, | 12 | 23.5 | 1.26 | 3.24 | 60 | 10.6 | 6.9 |
| common | | | | | | | |
| (blackeyes, | | | | | | | |
| crowder, | | | | | | | |
| southern), | | | | | | | |
| mature seeds, | | | | | | | |
| raw | | | | | | | |
| French beans, | 10.8 | 18.8 | 2.02 | 4.3 | 64.1 | 25.2 | — |
| mature seeds, | | | | | | | |
| raw | | | | | | | |
| Kidney beans, | 11.8 | 22.5 | 1.06 | 3.37 | 61.3 | 15.2 | 2.1 |
| red, mature | | | | | | | |
| seeds, raw | | | | | | | |
| Lentils, raw | 8.26 | 24.6 | 1.06 | 2.71 | 63.4 | 10.7 | 2.03 |
| Lupins, | 10.4 | 36.2 | 9.74 | 3.28 | 40.4 | 18.9 | — |
| mature seeds, | | | | | | | |
| raw | | | | | | | |
| Mungo beans, | 10.8 | 25.2 | 1.64 | 3.36 | 59 | 18.3 | — |
| mature seeds, | | | | | | | |
| raw | | | | | | | |
| Navy beans, | 12.1 | 22.3 | 1.5 | 3.32 | 60.8 | 26 | 3.88 |
| mature seeds, | | | | | | | |
| raw | | | | | | | |
| Peas, green, | 8.69 | 23.1 | 3.89 | 2.67 | 61.6 | 22.2 | 3.14 |
| split, mature | | | | | | | |
| seeds, raw | | | | | | | |
| Pigeon peas | 10.6 | 21.7 | 1.49 | 3.45 | 62.8 | 15 | — |
| (red gram), | | | | | | | |
| mature seeds, | | | | | | | |
| raw | | | | | | | |
| Pinto beans, | 11.3 | 21.4 | 1.23 | 3.46 | 62.6 | 15.5 | 2.11 |
| mature seeds, | | | | | | | |
| raw | | | | | | | |
| Sesame seeds, | 4.69 | 17.7 | 49.7 | 4.45 | 23.4 | 11.8 | 0.3 |
| whole, dried | | | | | | | |
| Soybeans, | 8.54 | 36.5 | 19.9 | 4.87 | 30.2 | 9.3 | 7.33 |
| mature seeds, | | | | | | | |
| raw | | | | | | | |

The inventors then assessed the protein (i.e. vicilin), polyphenol and lipid profiles of the nineteen legume candidates and assigned a similarity to cocoa score to each legume based on an aggregate scoring system. Where the relative abundance and protein profile of 7S fractions have been characterised, the legumes were scored in terms of their relative similarity to cocoa. Additional factors such as a polyphenolic profile rich in flavan-3-ols and procyanidins, or a high fat content were also taken into consideration. The table below summarises the profile and score achieved by the legume candidates.

TABLE 3
Comparison of key cocoa bean quality attributes between legume species

| | | | | | Vicilins | Compatible | | |
|---|---|---|---|---|---|---|---|---|
| | VCG protein profile (Δ 6 kDa) | | | | dominant | polyphenol | | |
| | 66 | 47 | 31 | 15 | storage | profile | Lipid | Total |
| Bean | kDa | kDa | kDa | kDa | protein | (up to 2) | booster | score |
| Adzuki | | | 1 | | 1 | 1 | | 3 |
| Alfalfa | | 1 | 1 | 1 | | | | 3 |
| Bambara | 1 | | | | 1 | | | 2 |
| Black | | 1 | | | 1 | 1 | | 3 |
| gram | | | | | | | | |
| Chickpea | | | 1 | 1 | | 1 | | 3 |
| Common | | 1 | | | 1 | 1 | | 3 |
| bean | | | | | | | | |
| Cowpea | | 1 | | | 1 | 1 | | 3 |
| Fava | | 1 | 1 | | | 2 | | 4 |
| Lentil | | 1 | | 1 | | 1 | | 3 |
| Lima | | | | | | | | 0 |
| Moth | | 1 | 1 | 1 | 1 | 1 | | 5 |
| Mung | | 1 | | | | | | 1 |
| Dried | | 1 | 1 | 1 | 1 | 1 | | 5 |
| Pea | | | | | | | | |
| Pigeon | | | | | | | | 0 |
| pea | | | | | | | | |
| Sesame | 1 | 1 | 1 | 1 | | | 1 | 5 |
| Scarlett | | 1 | 1 | 1 | 1 | | | 4 |
| runner | | | | | | | | |
| Soy | 1 | 1 | | | | | 1 | 3 |
| Vetch | 1 | | | | | | | 1 |
| White | 1 | 1 | 1 | 1 | 1 | | 1 | 6 |
| lupin | | | | | | | | |

As observed in the above table, out of the selected legume candidates, six legumes displayed characteristics more similar to cocoa beans (i.e. legumes with a total score ≥4) and include Fava, white lupin, pea, moth beans, Scarlett runner and sesame.

These six legumes were then fermented via the novel fermentation process.

### Example 2: Fermentation Process

Referring to FIG. 1A, there is shown the method for preparing a fermentation inoculum used in the fermentation of the legume. As can be seen, yeast and/or bacteria colonies are transferred to a suitable separate growth media. Two options are available, where option 1 involves combining both the yeast and bacteria into a single inoculum, and option 2 which involves keep the yeast and bacterial inocula separate.

Two different embodiments of fermentation protocol will now be described in which the first embodiment uses a combined (yeast and bacterial-option 1) inoculum throughout the entire fermentation, and the second embodiment uses a sequential, yeast followed by bacterial, inoculation and fermentation (option 2).

As shown in FIG. 1B, In one embodiment of the fermentation protocol, the chosen legume or combination of legumes (as discussed in Example 1) are prepared for the fermentation steps. This involves transferring the treated legume beans to a fermentation box (reactor) together with synthetic pulp acting as the fermentation media, and the yeast and/or bacterial inoculum. The combined microbial fermentation is then allowed to take place, for example incubation at 30 deg C. (ideal for the yeast cell growth and fermentation) for at least 48 hours after which the synthetic pulp (fermentation media) is discarded once the first fermentation has ended. The legumes are then stirred and further incubated with the combined micro-organisms at 42 deg C. (ideal for the bacterial cell growth and fermentation) for a further 72 hours. Once the second combined fermentation has ended, the legumes are dried, and can then be proceed as discussed in Examples 3 or 4.

As shown in FIG. 1C, in a second embodiment of the fermentation protocol, the chosen legume or combination of legumes (as discussed in Example 1) are prepared for the fermentation steps. This involves transferring the legume beans to a fermentation box (reactor) together with synthetic pulp and a yeast only inoculum. The yeast only fermentation is then allowed to take place, for example incubation at 30 deg C. for at least 48 hours after which the synthetic pulp is discarded once the first, yeast fermentation has ended. Then, a bacterial only inoculum is added to the fermentation box/reactor, and the legumes are then stirred and further incubated with the combined micro-organisms (yeast and bacteria) at 42 deg C. for a further 72 hours. Once the second combined fermentation has ended, the legumes are dried, and can then be proceed as discussed in Examples 3 or 4.

Referring to FIG. 4, there are shown various photographs of dried fava beans after 3 hr rehydration. (a) 0 hr, (b) 24 hr incubation, (c) 48 hr incubation, (d) 72 hr incubation, (e) 120 hr incubation, (f) dried beans after 120 hr fermentation, (g) dried unfermented beans.

### Example 3: Method of Making Chocolate Analogue Paste (e.g. For Toppings and Bars)

Referring to FIG. 2, there is shown an embodiment of a method for making a chocolate analogue paste.

Method for making the analogue chocolate paste:
1. The fermented and dried legumes were oven roasted at a temperature ranging from 180-280 deg C. for about 5-20 minutes.
2. The roasted legumes were cooled down and subsequently cracked in the CPL cracker and later winnowed in the CPL winnower.
3. The resulting nibs were then ground to a fine powder and fat added (cocoa butter replacement), weighed then warmed to about 30-35 deg C.
4. The warmed powder fat mix (liquor) were then refined in order to reduce the particle sizes and conched (i.e. gently mixed and heated) in the ECGC65 up to 16 hours depending on batch size to produce the liquor.
5. The resulting chocolate analogue liquor was further refined and conched as described above, after adding the relevant additives (for example, milk, Flavourings, sunflower lecithin, or sugar).
6. The chocolate analogue paste resulting from step 5 was then tempered in FBM temperer. The Temperature and time of the temper cycle will depend primarily on what fat is being used in the recipe.
7. Once tempered, the chocolate analogue paste was moulded and/or stored as desired.

Suitable storage conditions comprise storing the product in a cool dry place, at a temperature ranging between 10-20 C, in dry conditions and away from strong smells.

### Example 4: Method of Making Chocolate Analogue Powder (e.g. For Drinks)

Referring to FIG. 3, there is shown an exemplary embodiment of a method for making a chocolate analogue powder.

Method for making the analogue chocolate powder:
1. The fermented and dried legumes were oven roasted at a temperature ranging from 180-280 deg C. for about 5-20 minutes.
2. The roasted legumes were cooled down and subsequently cracked in the CPL cracker and later winnowed in the CPL winnower.
3. The resulting nibs were then ground to a fine powder to produce the cocoa powder analogue
4.

Suitable storage conditions comprise storing the product in a cool dry place, at a temperature ranging between 10-20 C, in dry conditions and away from strong smells.

It will be appreciated that melting temperature, solubility, consistency, mouthfeel etc will vary depending on the type of fats and sugars introduced into the chocolate analogue formulation. However, ultimately, they will all be very similar if not identical to those in actual cacao-based or derived chocolate compounds.

### Example 5: Development of a Processed Fava Bean Powder without the Use of Added Microbes

Example 1-4 described the use of microbial fermentation (yeast and/or bacteria) to treat the legume (e.g. fava bean) to result in a cacao bean-free chocolate analogue. However, following on from this work, the inventors then identified an exemplary method for making a cocoa analogue powder, without the use of added microbes, i.e. in the absence of any added micro-organisms. In this manner, a fourth embodiment of a legume-processing protocol will now be described, which uses a microbe-free incubation solution,

### 1. Surface Sterilization of Fava Beans

Vicia Fava (fava beans) were used.
For each fermentation replicate, 125 g of beans were weighed out using an analytical balance and transferred to a 500 mL reagent glass bottle.
Bean sterilization solution (70% ethanol, 0.05% Triton X-100 (catalogue number: T8787-250ML)) was prepared (200 mL for each fermentation replicate).
The sterilization solution was added to the beans and agitated at 200 rpm and 30° C. for 1 hr using a lab orbital shaker.

The following steps were performed under sterile conditions.
The sterilization solution was discarded using a sterile 25 mL disposable polystyrene serological pipette.
The beans were subsequently washed by adding 250 mL of sterile RO water to the bottle, mixed by inverting the bottle 10 times and discarding the wash. Repeated two more times for a total of 3 washes.

### 2. Rehydration of Beans.

Sterile RO water (250 mL) was added to the bottle and beans were incubated at 25° C. for 15-20 hr to rehydrate.

### 3. Incubation

The following steps were performed under sterile conditions.
Excess rehydration water was discarded, and the beans were transferred to a sterile SacO2 microbox (catalogue number: TP1600+TPD1600 #30 WH).
200 ml of incubation solution (recipe 1) were added. Use of sugars (2.5% sucrose, 4% glucose, 5% fructose)+1% citric acid is a simpler alternative with some reduction in flavour quality.

### Recipe 1:

2.5% (w/v) sucrose
4% (w/v) glucose
5% (w/v) fructose
1% (w/v) citric acid
0.14% (w/v) carboxymethyl cellulose high V
0.77% (w/v) carboxymethyl cellulose low V
1.09% (w/v) pectin
0.5% (w/v) yeast extract
0.5% (w/v) peptone
0.1% (w/v) calcium lactate pentahydrate
0.1% (v/v) Tween 80
0.05% (w/v) magnesium sulfate heptahydrate
0.02% (w/v) manganese sulfate monohydrate.
The beans were mixed, and the box was closed with the filtered lid and then incubated at 30° C.
After 48 hr, the incubation media was discarded, and the beans were mixed.

Visible contamination at this stage is associated with blocking of formation of ethanol and acetic acid (vinegar smell) at the 42° C. incubation, and produce bean powders that are more neutral pH, and no chocolate aroma (see Table 4).

TABLE 4
Significant relationships between bean powder pH, vinegar odour
of beans, microbial contamination of the incubation mixture,
and chocolate aroma of the roasted fava bean powder.

| NK001-NK0062 | Count | mean pH | SD |
|---|---|---|---|
| Chocolate | 30 | 5.6 | 0.7 |
| No chocolate | 133 | 6.2 | 0.7 |
| t-test | | 0.000011 | |
| Contamination 30° C. | 69 | 6.488405797 | 0.310377489 |
| No contamination 30° C. | 74 | 5.781081081 | 0.767075156 |
| t-test | | 4.70844E−11 | |
| | | mean vinegar | |
| NK001-NK0062 | Count | (24, 48, 72) | SD |
| Chocolate | 24 | 1.208333333 | 0.9770927 |
| No chocolate | 107 | 0.514018692 | 0.744343271 |
| t-test | | 0.000161556 | |
| Contamination 30° C. | 62 | 0.403225806 | 0.63915101 |
| No contamination 30° C. | 61 | 0.770491803 | 0.824488581 |
| t-test | | 0.006610549 | |

The beans were then incubated for an additional 72 hr at 42° C. Incubations that have a vinegar smell, and beans that look shiny and wet, produce good chocolate aroma powders with low pH (see Table 4).
Through the 30° C. incubation, the pH of the beans declines reaching pH 4.5. For beans that look shiny and wet the pH of the bean remained at pH 4.5 during the 42° C. incubation. For beans that do not look shiny and wet the pH raises again during 42° C. incubations to between pH 6.2-7.0

### 4. Drying.

Beans are then dried in a drying oven at 35° C. Drying time of 7 days for optimum aroma development of roasts bean powders.

### 5. Pre-Roasting Maturation of Beans

For optimum aroma development of roasted bean powders, beans are allowed to mature at room temperature for 5 days before roasting.
Dried beans can be stored for at least 10 days before roasting and grinding without any detrimental impact on powder aroma or change in powder pH.

### 6. Pre-Roasting Treatment to Develop Darker Colour

Grind dried beans, added water to powder (1:1 w/w) and heat to 80° C. for 60 min with occasional stirring. Dry paste at 35° C. for 7 days. Produces a darker powder with a darkness equivalent to undutched cocoa powder

### 7. Roasting and Grinding

Roasting & grinding of dried beans at 180 or 200° C. for 20-40 min to hit a predetermined colour, using a scale developed in house.
Roasting causes a drop of approximately 1 pH unit of powders made from non-shiny beans. The pH of shiny beans remained low around pH 5.0.
After roasting, beans can be kept for at least 2-3 months before grinding without any detrimental impact on powder aroma or change in powder pH.

### 8. Maturation of Roasted and Ground Powder

Detailed experiments have determined that aroma of roasted bean powder changes rapidly over the first 7 days after roasting and grinding. After 7 days, aroma is stable >1 month. The pH of the roasted powder is stable immediately after grinding up to 4 months.
Good chocolate aroma powders are associated with lower pH powders (Table 1), and, referring to FIG. 5, it is shown that a pH optimum for chocolate aroma is pH 4.8-5.1. Bin is a mathematical term used when creating a histogram from a continuous set of data. In the plot, there are 163 samples of the treated fava bean powder for which the pH is known, and if they have a chocolate aroma. The pH of the samples ranges from 4 to 7. To create the histogram, pH bins were created which are a narrow range of pH values e.g. 4.8-5.1. In that pH range (bin), the number of the powders with a pH within that range have a chocolate aroma are counted. The percentage of the samples in that pH bin have a chocolate aroma are calculated. This is repeated for for all bins between 4 and 7, and then those values were plotted. As such, samples with a pH 4.8-5.1 have the highest percentage of samples with a chocolate aroma (˜60%). Referring to FIG. 6, there is shown that, in powders with a lower pH, chocolate aroma starts to develop at day 3-4 after roasting and grinding, and is developed at day 7 and continues to improve for up to 1 month, after which it is stable for up to 4 months.

### 9. Flavour

Referring to FIG. 7, there is shown flavour profiles for liquors (powder+shea butter 1:1 w/w) made from processed roasted and ground fava bean powder, with authentic cocoa powder included for comparison. The flavour profile of roasted fava bean powder scores favourably for the various flavour elements tested, compared to authentic cocoa powders.

### Example 6: Addition of Microbes Develops Alternative Flavours of Fava Bean Powder

The inventors have discovered that the addition of different microbes results in the development of alternative flavours of the fava bean powder. In this manner, a fifth embodiment of a legume processing protocol will now be described, which uses a fermentation inoculum as described in option 1 (i.e., protocol 1 in FIG. 1B).

### 1. Surface Sterilization of Fava Beans

Vicia Fava (fava beans) were used.
For each fermentation replicate, 125 g of beans were weighed out using an analytical balance and transferred to a 500 mL reagent glass bottle.
Bean sterilization solution (70% ethanol, 0.05% Triton X-100 (catalogue number: T8787-250ML)) was prepared (200 mL for each fermentation replicate).
The sterilization solution was added to the beans and agitated at 200 rpm and 25° C. for 30 min using a lab orbital shaker.

The following steps were performed under sterile conditions.
The sterilization solution was discarded using a sterile 25 mL disposable polystyrene serological pipette.
The beans were subsequently washed by adding 250 ml of sterile RO water to the bottle, mixed by inverting the bottle 10 times and discarding the wash. Repeated two more times for a total of 3 washes.

### 2. Rehydration of Beans

Sterile RO water (250 mL) was added to the bottle and beans were incubated at 25° C. for 15-20 hr to rehydrate.

### 3. Incubation

The following steps were performed under sterile conditions.
Excess rehydration water was discarded, and the beans were transferred to a sterile SacO2 microbox (catalogue number: TP1600+TPD1600 #30 WH).
200 ml of incubation solution (recipe dependent on the microbe being added-see below) was added. Microbes used were Pichia kudriavzevii, Hanseniaspora opuntiae, Saccharomyces cerevisiae, Lactobacillus fermentum, Lactobacillus plantarum, and Acetobacter pasterianus. Beans were prepared and inoculated separately with one of the types of microbes used.
Fermentation inoculum was prepared as follows;
1. Selective agar was prepared, poured into sterile 9 cm petri dishes (20 mL each) and allowed to cool and harden.
Acetic Acid (AA) agar: 1% D-glucose, 1.5% bacteriological peptone, 0.8% yeast extract, 0.5% ethanol, 0.3% acetic acid and 2% agar. The mixture was sterilized by autoclaving. Note that the ethanol and acetic acid should be added after autoclaving (final pH of media should be 4.5).
De Man Rogosa Sharpe (MRS) agar: MRS agar (catalogue number: 69964-500G) was prepared according to the manufacturer's instructions. Briefly, 61. 15 g MRS agar was added to 800 mL RO water containing 1 ml TWEEN 80 (catalogue number: P8074). The suspension was boiled to completely dissolve the medium and the volume was adjusted to 1000 mL and then sterilized by autoclaving.
Yeast Peptone Glucose (YPG) agar: 1% yeast extract, 2% peptone, 2% glucose. Adjust the pH to 5.6, add 2% agar and autoclave.

TABLE 5
Selective agar for microflora

| Microorganism | Selective agar |
|---|---|
| Pichia kudriavzevii | YPG |
| Hanseniaspora opuntiae | YPG |
| Saccharomyces cerevisiae | YPG |
| Lactobacillus fermentum | MRS |
| Lactobacillus plantarum | MRS |
| Acetobacter pasterianus | AA |

2. Stocks of each cell culture were plated on their respective selective agar plate (Table 1) and incubated at 28° C. for 72 hr.
3 For each isolate, 15 mL tubes containing 3 mL of Luria broth Lennox were prepared except for Acetobacter pasterianus a 15 ml tube containing 3 mL of AA broth (1% D-glucose, 1.5% bacteriological peptone, 0.8% yeast extract. Autoclave and add 0.5% ethanol and 0.3% acetic acid) were prepared.
4. A single colony from the agar plate was selected for each isolate and transferred to the 3 mL of the respective growth media and incubated at 28° C. at 200 rpm in a shaking incubator for 72 hr.
5. The cells were harvested by centrifuging at 4,000×rpm at 4° C. for 8 min.
6. The supernatant was discarded and 5 mL of sterile 10 mM MgCl2 were added to the tubes.
7. The tubes were inverted 10 times to resuspend the cells and centrifuged at 4,000×rpm at 4° C. for 8 min.
8. Steps 6-7 were repeated 2 more times for a total of 3 washes.
9. The cells were resuspended in 1 mL sterile 10 mM MgCl2 and the optical density at 600 nm (OD600) was measured for each isolate (1 OD 600=1×109 cells/mL) to determine cell concentrations.
10. The fermentation inoculum was prepared by pooling the individual isolates, with the concentration of each isolate being 1×10⁸ cells/mL (sterile 10 mM MgCl2 was used to dilute the cells when necessary). For each fermentation, 1 mL of inoculum was prepared and used immediately or stored at 4° C. for no longer than 24 hr.
The beans were mixed with the inoculum and the box was closed with the filtered lid and then incubated at 30° C.
After 72 hr, the incubation media was discarded, and the beans were mixed.

### 4. Drying

Beans are then dried in a drying oven at 35° C. Drying time of 7 days for optimum aroma development of roasted bean powders.

### 5. Roasting and Grinding

Roasting & grinding of dried beans at 180 or 200° C. for 20-40 min to hit a predetermined colour, using a scale developed in house.

### 6. Flavour

Referring to FIG. 8, flavour profiles for liquors (bean powder, sugar and shea butter) made from processed roasted and ground fava bean powder are shown, with fava beans (NK0034) treated using our non-microbial process included for comparison. Flavour evaluated by 5 independent individuals.

Furthermore, referring to FIG. 1D, a further embodiment has been developed which involves two separate treatments of the legume (e.g. Fava bean), the products of which are then blended together to produce the cacao bean-free cocoa powder analogue. Firstly, the legume is treated by micro-organisms (either option 1 or option 2), to produce a microbially fermented legume. Separately, the legume is treated in the absence of any micro-organisms to produce non-microbially treated legume. Subsequently, a proportion of the microbially fermented legume is blended with a proportion of the non-microbially treated legume to result in the cacao bean-free cocoa powder analogue.

As such, it is shown that the fava bean treatment process with various microbes produces different flavours than the non-microbial process described in Example 5, and blending of beans from both types of processes, namely microbial and non-microbial fermentation, produces unique flavour combinations.

### Example 7: Use of Other Beans

The inventors have discovered that beans other than the fava bean may also be used to develop cocoa-like powder., Lupin, green pea, moth, aduki and hemp seeds were treated following the same procedure as for the fava beans according to the legume-processing protocol described in Example 5, that being the fourth protocol, which uses a microbe-free incubation solution. Flavours for liquors (powder mixed with shea butter 1:1) produced from processed seeds and beans are shown in FIG. 10.

As such, it is shown that all the beans and seeds tested have distinct flavour profiles from each other, and from fava bean. Furthermore, it is shown that hemp seed and lupin bean compare favourably for chocolate taste with fava bean. The inventors have also concluded that powders made from the various treated beans could be blended with fava bean powder to create improved flavour profiles, (e.g., with reference to FIG. 10, blending hemp seed with fava bean would introduce new flavours of acidity, dried fruit and nutty to the fava bean powder).

### Example 8: Use of Fava Bean Powder and Additives to Create NuKoKo Cocoa-Like Powder

Various additives to modify the flavour of the powder can be added to the fava bean powder created from either microbially or non-microbially fermented beans, that have been roasted and ground, and either blended or not blended. an. These flavour modifying ingredients are added at the 0.1-2.0% (w/w) range. They include, but are not limited to, beetroot powder, apple powder, and malt barley.

### Example 9: Use of “NuKoKo” Powder to Create Cocoa-Free Chocolate Analogue

The inventors have identified an exemplary method for making cocoa-free chocolate analogue using the cacao bean-free chocolate analogue powder of the invention (i.e. “Nukoko” powders) that are the result of the fava bean treatment processes laid out in Example 5 and/or Example 6.
1. NuKoKo chocolate analogue was prepared with the following recipe: 21% 410 g Nukoko powder
34% 665 g Palm/shea fat
24% 469 g Cane sugar (pre-ground)
14% 274 g whole milk powder
2% 39 g beetroot powder
2% 39 g apple powder
0.5% 10 g lecithin
2% 39 g malt extract
0.2% 3.5 g salt (pre-ground)
0.25% 5 g Chocolate malt barley
2. Method: Fat melted, grainy ingredients pre-ground (spice grinder). Half-dry ingredients added to liquid fat and then into pre-heated small stone grinder. Balance of dry ingredients added.

Heat lamp used on batch. Run for 8 hours.
3. Appearance: It has to be smooth, evenly coloured, and with a sheen.

It should not have air bubbles, cracks, streaks, or a cloudy appearance.
4. Aroma: It should smell richly of chocolate, with fruity, earthy, or floral undertones.
5. Snap: It should have a clear, crisp, clean, and sharp snap when broken.
6. Texture: It should melt the moment you put it in your mouth. Its flavour and smoothness should instantly strike you. It should feel smooth and velvety in your mouth. The flavour should linger for a few minutes after you finish the piece of chocolate.
7. Flavour: It should taste sweet, milky, caramel and cocoa.
8. Flavour profiles
   Referring to FIG. 9, flavour profiles of NuKoKo chocolate analogue (Choc), authentic Tesco-brand Milk Chocolate, and Dark Chocolate (Mollys) are shown. Various chocolate flavour elements were evaluated by 5 independent individuals.

As such, there is provided a direct comparison between NuKoKo Choc (chocolate substitute made from fava bean powder, according to the above recipe, processed using the inventors' non-microbial method) and Tesco's milk and dark chocolates. The NuKoKo Choc scores very similarly to authentic chocolate on all five of the parameters tested, namely appearance, aroma, snap, texture, and flavour.

### SUMMARY

As described in the Examples, the inventors have developed an elegant process for manufacturing a chocolate analogue which is not derived from the cacao bean and so does not include any cocoa. Instead, the process involves the use of a highly selected group of legumes which meet the requisite criteria for replicating the look, taste, odour and mouthfeel of traditional cacao-derived chocolate, but which do not suffer cacao/cocoa drawbacks. The non-cacao chocolate analogue can be made either into paste or powder and can therefore be used a variety of foodstuffs, such as solid confectionary or cosmetics.

1. A method of producing a cacao bean-free chocolate analogue, the method comprising contacting a legume with at least one micro-organism under conditions suitable for the at least one micro-organism to ferment the legume to thereby form a cacao bean-free chocolate analogue comprising a microbially fermented legume.

2. The method according to claim 1, wherein the method comprises a first treatment in which the legume is microbially fermented, to produce a microbially fermented legume, and a second treatment in which, separately, the legume is non-microbially fermented in the absence of any exogenously added micro-organisms to produce non-microbially treated legume.

3. The method according to claim 2, wherein the method comprises combining a proportion of the microbially fermented legume with a proportion of the non-microbially fermented legume to result in the cacao bean-free chocolate analogue.

4. The method according to claim 3, wherein the ratio of microbially fermented legume to non-microbially fermented legume is between about 10%: 90% and 90%: 10%, or about 50%: 50%.

5. The method according to any preceding claim, wherein the fermented legume is selected from a group of legumes consisting of: adzuki bean (Phaseolus angularis); alfalfa (Medicago sativa); bambara (vigna subterranean); black gram (vigna mungo); chickpea (Cicer arietinum); cowpea (vigna unguiculata); fava bean (Vicia faba); common bean (Phaseolus vulgaris); lima bean (Phaseolus lunatus); lentils (lens culinaris or Lens esculenta); lupins (lupinus albus, lupinus angustifolius, or lupinus luteus); moth bean (vigna aconitifolia); mung bean (vigna radiate); pea (Pisum sativum); pigeon pea (cajanus cajan); sesame (Sesamum indicum); scarlett runner bean (Phaseolus coccineus); soy (glycine max); and vetch (Vicia sativa).

6. The method according to any preceding claim, wherein the fermented legume is selected from the group consisting of: fava bean (Vicia faba); white lupin (lupinus albus); pea (Pisum sativum); moth bean (vigna aconitifolia); Scarlett runner bean (Phaseolus coccineus); and sesame (Sesamum indicum).

7. The method according to any preceding claim, wherein the at least one micro-organism used for the fermentation is selected from a yeast and/or a bacterium.

8. The method according to any preceding claim, wherein the fermentation comprises substantially or only yeast, optionally wherein at least 70%, 80% or 90% of the micro-organisms in the fermentation comprise yeast cells.

9. The method according to any preceding claim, wherein the fermentation comprises substantially or only bacteria, optionally wherein at least 70%, 80% or 90% of the micro-organisms in the fermentation comprise bacterial cells.

10. The method according to any preceding claim, wherein the fermentation comprises yeast and bacteria, preferably wherein the ratio of yeast to bacterial cells is about 50:50, 10:90, 20:80, 30:70, 40:60 yeast cells to bacterial cells, or 10:90, 20:80, 30:70, 40:60 bacterial cells to yeast cells.

11. The method according to any one of claims 4-7, wherein the Family of bacterium is selected from a group of bacteria Families consisting of: Lactobacillales; and Acetobacter.

12. The method according to any one of claims 4-8, wherein the species of bacterium is selected from a group of bacterial species consisting of: Lactobacillus fermentum; Lactobacillus plantarum; and Acetobacter pasterianus.

13. The method according to any one of claims 4-9, wherein the genus of yeast is selected from a group of yeast genuses consisting of: Pichia; Hanseniaspora; and Saccharomyces.

14. The method according to any one of claims 4-10, wherein the species of yeast is selected from a group of yeast species consisting of: Pichia kudriavzevii; Hanseniaspora opuntiae; and Saccharomyces cerevisiae.

15. The method according to any preceding claim, wherein the method comprises growing the at least one micro-organism and the legume in growth media, optionally wherein the growth media comprises:
(i) one or more saccharide selected from a group consisting of: sucrose;
glucose; fructose; carboxymethyl cellulose high V; carboxymethyl cellulose low V; and/or pectin;
(ii) one or more salt selected from a group consisting of: calcium lactate pentahydrate; magnesium sulfate heptahydrate; and manganese sulfate monohydrate;
(iii) one or more protein hydrolysate, optional wherein the protein hydrolysate is peptone;
(iv) yeast extract;
(v) surfactant, optionally Tween 80; and/or
(vi) citric acid.

16. The method according to any preceding claim, wherein the growth media has a pH of 2-5 or 3-4.

17. The method according to any preceding claim, wherein the fermentation comprises incubating yeast and bacteria at 24° C.-44° C. for at least 1 or 2 days.

18. The method according to any preceding claim, wherein the fermentation comprises incubating bacteria at 24° C.-50° C. for at least 1 or 2 days.

19. The method according to any preceding claim, wherein the method comprises simultaneously fermenting the legume in the presence of yeast and bacteria.

20. The method according to claim 16, wherein the yeast comprises Pichia kudriavzevii, Hanseniaspora opuntiae, and/or Saccharomyces cerevisiae, and the bacteria comprises Lactobacillus fermentum, Lactobacillus plantarum, and/or Acetobacter pasterianus.

21. The method according to either claim 16 or claim 17, wherein the method comprises contacting the legume with yeast and bacterial cells for at least 24 hours at a temperature of 21° C.-37° C., discarding the growth media after the one or more days of initial fermentation, and then incubating the legume and at least one micro-organism for one or more days at a temperature of 24° C.-50° C.

22. The method according to any one of claims 16-18, wherein the fermentation mixture is incubated at a temperature of 34° C.-44° for at least two or three days.

23. The method according to any one of claims 1-15, wherein the method comprises initially fermenting the legume in the presence of only yeast, and then subsequently in the presence of bacteria.

24. The method according to claim 20, wherein the yeast comprises Pichia kudriavzevii, Hanseniaspora opuntiae, and/or Saccharomyces cerevisiae, and the bacteria comprises Lactobacillus fermentum, Lactobacillus plantarum, and/or Acetobacter pasterianus.

25. The method according to either claim 20 or claim 21, wherein the method comprises contacting the legume with yeast cells for at least 24 hours at a temperature of 21° C.-37° C., discarding the growth media after the one or more days of initial fermentation, and then contacting the fermented legume with bacterial cells for at least 24 hours at a temperature of 24° C.-50° C.

26. The method according to any one of claims 20-22, wherein the fermentation mixture is incubated at a temperature of 32° C.-44° C., for at least two or three days.

27. The method according to any one of claims 2-26, wherein when the method comprises non-microbial fermentation, the method comprises use of an incubation medium having a pH of between 3 and 5, and submerging the legume as it starts to germinate to consume the available oxygen for respiration, such that fermentative metabolism is initiated with the oxidation of sugars leading to the production of ethanol, lactic acid and optionally acetic acid.

28. The method according to claim 27, wherein the non-microbial fermentation is incubated at a first temperature of 20° C.-38° C., 23° C.-37° C., 24° C.-36° C., 25° C.-35° C., 26° C.-34° C., 27° C.-33° C., 28° C.-32° C., or 29° C.-31° C.

29. The method according to claim 27 or claim 28, wherein the non-microbial fermentation is incubated at least one or two days.

30. The method according to any one of claims 27-29, wherein the non-microbial fermentation mixture is incubated at a second temperature of 26° C.-48° C., 28° C.-46° C., 30° C.-44° C., 32° C.-44° C., 34° C.-44° C., 36° C.-44° C., 38° C.-44° C., or 40° C.-44° C.

31. The method of claim 30, wherein the non-microbial fermentation is incubated for at least one, two or three days.

32. The method according to any preceding claim, wherein the chocolate analogue has a pH of:
(i) between about 4 and about 7, between about 4.3 and about 6.8, or between about 4.4 and about 6.7;
(ii) between about 4.4 and about 6.3, between about 4.7 and about 5.9, or between about 4.7 and about 5.5; or
(iii) between about 4.4 and about 5.5, between about 4.7 and about 5.2, or between about 4.8 and about 5.1.

33. The method according to any preceding claim, wherein the method comprises drying the legume after fermentation, optionally wherein the legume is dried in an oven for one or more days at a temperature of about 21° C.-37° C.

34. The method according to any preceding claim, wherein the cacao bean-free chocolate analogue comprising fermented legume comprises or is converted into a paste.

35. The method according to any preceding claim, wherein the cacao bean-free chocolate analogue comprising fermented legume comprises or is converted into a powder.

36. A cacao bean-free chocolate analogue obtained, or obtainable, by the method according to any one of claims 1-35.

37. A cacao bean-free chocolate analogue comprising a microbially and/or non-microbially fermented legume.

38. The cacao bean-free chocolate analogue according to claim 37, wherein the analogue is defined as in any one of claims 1-35.

39. A product ingredient comprising the cacao bean-free chocolate analogue according to any one of claims 36-38.

40. A foodstuff or beverage comprising the cacao bean-free chocolate analogue according to any one of claims 36-38, or the ingredient according to claim 39, optionally wherein the cacao bean-free chocolate analogue is a powder, liquor, liquid, solid, or in a paste form.

41. The foodstuff or beverage according to claim 40, wherein the foodstuff is a confectionary product, optionally wherein the foodstuff is a block bar, moulded figure, button, truffle, spread, coated fruit, nuts or other inners, bakery filling, coating on a product, such as a donut or muffin, yoghurt, ice cream or other dessert.

42. A cosmetic product comprising the cacao bean-free chocolate analogue according to any one of claims 36-38, or the ingredient according to claim 39.

43. The cosmetic product according to claim 42, wherein the cosmetic is a skin care product, a moisturizer, an exfoliator, lip balm, eye shadow, soap, body cream or butter, or a hair mask.
